(19) United States
(12) Patent Application Publication
(10) Pub. No.: US 2011/0188626 A1
(43) Pub. Date: Aug. 4, 2011

(54) Damage Evaluation Apparatus, and Damage Evaluation Method

(75) Inventors: Akihiro Moriyoshi, Hokkaido (JP); Shozo Tazoe, Tokyo (JP)

(73) Assignees: National University Corporation Hokkaido University, Sapporo-shi, Hokkaido (JP); Japan Radio Co., Ltd.,, Tokyo (JP)

(21) Appl. No.: 11/920,967

(22) PCT Filed: May 24, 2006
(86) PCT No.: PCT/JP2006/310404

§ 371 Date: Sep. 1, 2009

(30) Foreign Application Priority Data
May 24, 2005 (JP) 2005-151581

(51) Int. Cl. G01N 23/04

(52) U.S. Cl. 378/19

(57) ABSTRACT

Provided is a damage evaluation apparatus capable of evaluating the damage of an asphalt mixture or the like non-destructively for a short time and in a precise manner. This apparatus turns a sample (S) and irradiates it at every predetermined angle with an X-ray so that it detects the transmitted X-ray with an X-ray detector (104). An image reconstruction unit (122) creates multiple sheets of slice image data reconstructing the inside state of the sample (S) by using the detection results of the X-ray detector (104). An image processing unit (124) creates three-dimensional CT image data of the inside of the sample (S) with the slice image data created by the image reconstruction unit (122). A cavity analyzing unit (126) calculates the quantitative data of the inside state of the sample (S) with a predetermined calculation algorithm by using the slice image data created by the image reconstruction unit (122). A damage decision unit (128) decides the damage state in accordance with a predetermined decision standard by using the analysis result of the cavity analyzing unit (126).

### TECHNICAL FIELD

The present invention relates to a damage evaluation apparatus and a damage evaluation method. More particularly, the present invention relates to an apparatus and a method for evaluating damages to an asphalt mixture, a cement concrete mixture, or the like.

### BACKGROUND ART

For pavements, dams, waterways, banks, buildings, and bridges, for example, which are infrastructure in the field of civil engineering, architecture, and the like, an asphalt mixture, a cement concrete mixture, polymer concrete or plastics (hereinafter, referred to as an “asphalt mixture or the like”) is used.

Conventionally, damage evaluation of an asphalt mixture or the like is generally performed by performing mechanical testing such as compression and tensile testing on a sample cut out at a site and measuring the degree of damage from results (numeric values) of the experiment, the degree of deformation, and the magnitude of strength.

Recently, for a damage evaluation method for an asphalt mixture or the like, in addition to a method in which mechanical testing is performed, various methods have been considered.

For example, Non-Patent Document 1 describes a method for testing density of a compacted asphalt mixture. In this method, the dry weight of an asphalt mixture is measured, and thereafter, the surface of the asphalt mixture is coated with paraffin, the weight in water is measured, and then the void ratio of the asphalt mixture and the percentage of asphalt in voids of the aggregate (that is, voids filled with asphalt (VFA)) are decided by using the specific gravity and grading of aggregate to be used.

Patent Document 1 describes a cavity detection method in which cavities created in the middle and lower portions of an asphalt mixture layer are displayed as an image by using an electromagnetic wave so that even an unskilled person can easily search for cavities.

Patent Document 2 describes a diagnostic system in which the internal conditions or peripheral conditions of a concrete structure are perspectively learned using an electromagnetic wave, enabling to visually determine, for example, arrangement of reinforcing bars or occurrence of internal abnormal voids by using a two-dimensional image, a three-dimensional image, or the like.
Patent Document 1: Japanese Patent Application Laid-Open No. 9-133642
Patent Document 2: Japanese Patent Application Laid-Open No. 9-88351
Non-Patent Document 1: “Handbook of Test Methods for Pavement”, Japan Road Association, November 1988, pp. 574-581

### DISCLOSURE OF INVENTION

### Problems to be Solved by the Invention

However, in the method described in Non-Patent Document 1, upon testing, steps are performed in which, after an asphalt mixture is dried and the weight (dry weight) at that time is measured, the surface of the asphalt mixture is coated with paraffin, and the weight in water is measured, and therefore there is a problem that it requires a fixed period of time (for example, one day) to obtain measurement results.

In the methods described in Patent Documents 1 and 2, both methods use a reflected wave of an electromagnetic wave, and there is a fixed limit to damage evaluation of an asphalt mixture or the like. That is, when a reflected wave is used, a reflected wave cannot be obtained from a portion shadowed by an object such as a metal object, and thus, there is a portion that cannot be seen. In addition, generally, image quality is also significantly inferior to X-ray image quality. Moreover, generally, the resolution is substantially 2 to 15 cm, and thus, for example, two voids (cavities) spaced a few centimeters from each other are seen as one void (cavity), and the location thereof is also greatly shifted. Therefore, damage to an asphalt mixture or the like, for example, a distribution of voids in a pavement or the degree of change thereof, cannot be accurately measured.

Although there is a method using a density meter which uses a radioactive isotope, which is a type of nondestructive testing, there is a problem that with this method voids cannot be accurately measured.

The present invention is implemented in view of the above-described problems, and it is therefore an object of the present invention to provide a damage evaluation apparatus and a damage evaluation method that are capable of nondestructively and accurately evaluating damage to an asphalt mixture or the like in a short period of time.

### Means for Solving the Problem

According to one aspect of the present invention, there is provided a damage evaluation apparatus including: an irradiating section that irradiates a transmissive X-ray onto an evaluation object formed with a mixture, per predetermined angle; a detecting section that is disposed opposite to the irradiating section put the evaluation object into between sections that detects the X-ray transmitted through the evaluation object; an obtaining section that obtains, using a detection result of the detecting section, an internal state of the evaluation object in a form of three-dimensional CT image data; a calculating section that calculates, using the three-dimensional CT image data, characteristic data of the internal state of the evaluation object; and a determining section that determines, using the characteristic data, a damage state of an inside of the evaluation object according to a predetermined determination criterion, wherein: the characteristic data is information of a void or information of a crack between voids; and the determining section determines the damage state of the inside of the evaluation object by comparing the information of a void or the information of a crack between voids with a predetermined threshold value.

According to another aspect of the present invention, there is provided a damage evaluation method including: an irradiation step of irradiating a transmissive X-ray onto an evaluation object formed with a mixture, per predetermined angle; a detection step of detecting the X-ray transmitted through the evaluation object; an obtaining step of obtaining, using a detection result in the detection step, an internal state of the evaluation object in a form of three-dimensional CT image data; a calculation step of calculating, using the three-dimensional CT image data, characteristic data of the internal state of the evaluation object; and a determination step of determining, using the characteristic data, a damage state of an inside of the evaluation object according to a predetermined determination criterion, wherein: the characteristic data is information of a void or information of a crack between voids; and the determination step determines the damage state of the inside of the evaluation object by comparing the information of a void or the information of a crack between voids with a predetermined threshold value.

### Advantageous Effect of the Invention

According to the present invention, damage to an asphalt mixture or the like can be nondestructively and accurately evaluated in a short period of time.

### BRIEF DESCRIPTION OF DRAWINGS

FIG. 1 is a block diagram showing a configuration of a damage evaluation apparatus according to Embodiment 1 of the present invention;

FIG. 2 is a block diagram showing a configuration of a computer main body shown in FIG. 1;

FIG. 3 is a flowchart showing an operation of the damage evaluation apparatus according to the present embodiment;

FIG. 4 shows a configuration of an asphalt pavement;

FIG. 5 shows void analysis results for a sample of an upper portion of a surface course of a new drainage asphalt pavement, and FIG. 5(A) is a graph showing a distribution by pore volume, FIG. 5(B) is a graph showing a distribution of the effective radii of pores, FIG. 5(C) is a graph showing a relationship between the sizes of adjacent pores, and FIG. 5(D) is a graph showing how many pores, by effective radius, are connected to a pore;

FIG. 6 shows void analysis results for the sample of the upper portion of the surface course of the new drainage asphalt pavement, and FIG. 6(A) is a graph showing a distribution by throat area, FIG. 6(B) is a graph showing a distribution of the effective radii of throats, FIG. 6(C) is a graph showing a relationship between the sizes of a throat and pores adjacent to both sides of the throat, and FIG. 6(D) is a graph showing how thin a throat is with respect to a pore;

FIG. 7 shows void analysis results for the sample of the upper portion of the surface course of the new drainage asphalt pavement, and FIG. 7(A) is a plane view of a three-dimensional CT image, and FIG. 7(B) shows three-dimensional computer graphics showing a void analysis result for the three-dimensional CT image in FIG. 7(A);

FIG. 8 shows void analysis results for the sample of the upper portion of the surface course of the new drainage asphalt pavement, and FIG. 8(A) is a side view of a three-dimensional CT image, and FIG. 8(B) shows three-dimensional computer graphics showing a void analysis result for the three-dimensional CT image in FIG. 8(A);

FIG. 9 shows void analysis results for the sample of the upper portion of the surface course of the new drainage asphalt pavement, and FIG. 9(A) is a front view of a three-dimensional CT image, and FIG. 9(B) shows three-dimensional computer graphics showing a void analysis result for the three-dimensional CT image in FIG. 9(A);

FIG. 10 shows void analysis results for a sample of a lower portion of the surface course of the new drainage asphalt pavement, and FIG. 10(A) is a graph showing a distribution by pore volume, FIG. 10(B) is a graph showing a distribution of the effective radii of pores, FIG. 10(C) is a graph showing a relationship between the sizes of adjacent pores, and FIG. 10(D) is a graph showing how many pores, by effective radius, are connected to a pore;

FIG. 11 shows void analysis results for the sample of the lower portion of the surface course of the new drainage asphalt pavement, and FIG. 11(A) is a graph showing a distribution by throat area, FIG. 11(B) is a graph showing a distribution of the effective radii of throats, FIG. 11(C) is a graph showing a relationship between the sizes of a throat and pores adjacent thereto, and FIG. 11(D) is a graph showing how thin a throat is with respect to a pore;

FIG. 12 shows void analysis results for the sample of the lower portion of the surface course of the new drainage asphalt pavement, and FIG. 12(A) is a plane view of a three-dimensional CT image, and FIG. 12(B) shows three-dimensional computer graphics showing a void analysis result for the three-dimensional CT image in FIG. 12(A);

FIG. 13 shows void analysis results for the sample of the lower portion of the surface course of the new drainage asphalt pavement, and FIG. 13(A) is a side view of a three-dimensional CT image, and FIG. 13(B) shows three-dimensional computer graphics showing a void analysis result for the three-dimensional CT image in FIG. 13(A);

FIG. 14 shows void analysis results for the sample of the lower portion of the surface course of the new drainage asphalt pavement, and FIG. 14(A) is a front view of a three-dimensional CT image, and FIG. 14(B) shows three-dimensional computer graphics showing a void analysis result for the three-dimensional CT image in FIG. 14(A);

FIG. 15 shows void analysis results for a sample of the first layer of a base course of a coarse-graded type mixture of an existing asphalt pavement, and FIG. 15(A) is a graph showing a distribution by pore volume, FIG. 15(B) is a graph showing a distribution of the effective radii of pores, FIG. 15(C) is a graph showing a relationship between the sizes of adjacent pores, and FIG. 15(D) is a graph showing how many pores, by effective radius, are connected to a pore;

FIG. 16 shows void analysis results for the sample of the first layer of the base course of the coarse-graded type mixture of the existing asphalt pavement, and FIG. 16(A) is a graph showing a distribution by throat area, FIG. 16(B) is a graph showing a distribution of the effective radii of throats, FIG. 16(C) is a graph showing a relationship between the sizes of a throat and pores adjacent thereto, and FIG. 16(D) is a graph showing how thin a throat is with respect to a pore;

FIG. 17 shows void analysis results for the sample of the first layer of the base course of the coarse-graded type mixture of the existing asphalt pavement, and FIG. 17(A) is a plane view of a three-dimensional CT image, and FIG. 17(B) shows three-dimensional computer graphics showing a void analysis result for the three-dimensional CT image in FIG. 17(A);

FIG. 18 shows void analysis results for the sample of the first layer of the base course of the coarse-graded type mixture of the existing asphalt pavement, and FIG. 18(A) is a front view of a three-dimensional CT image, and FIG. 18(B) shows three-dimensional computer graphics showing a void analysis result for the three-dimensional CT image in FIG. 18(A);

FIG. 19 shows void analysis results for the sample of the first layer of the base course of the coarse-graded type mixture of the existing asphalt pavement, and FIG. 19(A) is aside view of a three-dimensional CT image, and FIG. 19(B) shows three-dimensional computer graphics showing a void analysis result for the three-dimensional CT image in FIG. 19(A);

FIG. 20 shows void analysis results for a sample of the second layer of the base course of the coarse-graded type mixture of the existing asphalt pavement, and FIG. 20(A) is a graph showing a distribution by pore volume, FIG. 20(B) is a graph showing a distribution of the effective radii of pores, FIG. 20(C) is a graph showing a relationship between the sizes of adjacent pores, and FIG. 20(D) is a graph showing how many pores, by effective radius, are connected to a pore;

FIG. 21 shows void analysis results for the sample of the second layer of the base course of the coarse-graded type mixture of the existing asphalt pavement, and FIG. 21(A) is a graph showing a distribution by throat area, FIG. 21(B) is a graph showing a distribution of the effective radii of throats, FIG. 21(C) is a graph showing a relationship between the sizes of a throat and pores adjacent thereto, and FIG. 21(D) is a graph showing how thin a throat is with respect to a pore;

FIG. 22 shows void analysis results for the sample of the second layer of the base course of the coarse-graded type mixture of the existing asphalt pavement, and FIG. 22(A) is a plane view of a three-dimensional CT image, and FIG. 22(B) shows three-dimensional computer graphics showing a void analysis result for the three-dimensional CT image in FIG. 22(A);

FIG. 23 shows void analysis results for the sample of the second layer of the base course of the coarse-graded type mixture of the existing asphalt pavement, and FIG. 23(A) is a front view of a three-dimensional CT image, and FIG. 23(B) shows three-dimensional computer graphics showing a void analysis result for the three-dimensional CT image in FIG. 23(A);

FIG. 24 shows void analysis results for the sample of the second layer of the base course of the coarse-graded type mixture of the existing asphalt pavement, and FIG. 24(A) is a side view of a three-dimensional CT image, and FIG. 24(B) shows three-dimensional computer graphics showing a void analysis result for the three-dimensional CT image in FIG. 24(A);

FIG. 25 shows void analysis results for a sample of the third layer of a base course of a coarse-graded type mixture of a new asphalt pavement, and FIG. 25(A) is a graph showing a distribution by pore volume, FIG. 25(B) is a graph showing a distribution of the effective radii of pores, FIG. 25(C) is a graph showing a relationship between the sizes of adjacent pores, and FIG. 25(D) is a graph showing how many pores, by effective radius, are connected to a pore;

FIG. 26 shows void analysis results for the sample of the third layer of the base course of the coarse-graded type mixture of the new asphalt pavement, and FIG. 26(A) is a graph showing a distribution by throat area, FIG. 26(B) is a graph showing a distribution of the effective radii of throats, FIG. 26(C) is a graph showing a relationship between the sizes of a throat and pores adjacent thereto, and FIG. 26(D) is a graph showing how thin a throat is with respect to a pore;

FIG. 27 shows void analysis results for the sample of the third layer of the base course of the coarse-graded type mixture of the new asphalt pavement, and FIG. 27(A) is a plane view of a three-dimensional CT image, and FIG. 27(B) shows three-dimensional computer graphics showing a void analysis result for the three-dimensional CT image in FIG. 27(A);

FIG. 28 shows void analysis results for the sample of the third layer of the base course of the coarse-graded type mixture of the new asphalt pavement, and FIG. 28(A) is a side view of a three-dimensional CT image, and FIG. 28(B) shows three-dimensional computer graphics showing a void analysis result for the three-dimensional CT image in FIG. 28(A);

FIG. 29 shows void analysis results for the sample of the third layer of the base course of the coarse-graded type mixture of the new asphalt pavement, and FIG. 29(A) is a front view of a three-dimensional CT image, and FIG. 29(B) shows three-dimensional computer graphics showing a void analysis result for the three-dimensional CT image in FIG. 29(A);

FIG. 30 shows three-dimensional computer graphics showing void analysis results for three-dimensional CT images (plane view) of samples having a recycled material mixed therein which are shown in table 18, and FIG. 30(A) shows the case of “dense grade” (standard dense-graded type mixture) in table 18, FIG. 30(B) shows the case of “dense grade+20% modification” (20% of a recycled material of modified asphalt is added) in table 18, FIG. 30(C) shows the case of “dense grade+50% modification” (50% of a recycled material of modified asphalt is added) in table 18, FIG. 30(D) shows the case of “dense grade+20% drainage” (20% of a recycled material of drainage asphalt is added) in table 18, and FIG. 30(E) shows the case of “dense grade+50% drainage” (50% of a recycled material of drainage asphalt is added) in table 18;

FIG. 31 shows computer graphics showing a sample in FIG. 30(A) as seen from different angles, and FIG. 31(A) shows three-dimensional computer graphics showing avoid analysis result for a three-dimensional CT image (plane view) of the sample, FIG. 31(B) shows three-dimensional computer graphics showing a void analysis result for a three-dimensional CT image (side view) of the sample, and FIG. 31(C) shows three-dimensional computer graphics showing a void analysis result for a three-dimensional CT image (side view as seen from an arrow direction in FIG. 31(A)) of the sample;

FIG. 32 shows computer graphics showing a sample in FIG. 30(B) as seen from different angles, and FIG. 32(A) shows three-dimensional computer graphics showing avoid analysis result for a three-dimensional CT image (plane view) of the sample, FIG. 32(B) shows three-dimensional computer graphics showing a void analysis result for a three-dimensional CT image (side view) of the sample, and FIG. 32(C) shows three-dimensional computer graphics showing a void analysis result for a three-dimensional CT image (side view as seen from an arrow direction in FIG. 32(A)) of the sample;

FIG. 33 shows three-dimensional computer graphics showing void analysis results for three-dimensional CT images of a sample of No. 10 shown in table 20, and FIG. 33(A) shows the case of a standard (plane view), FIG. 33(B) shows the case of a 15-degree turn, FIG. 33(C) shows the case of a 30-degree turn, and FIG. 33(D) shows the case of a 45-degree turn;

FIG. 34 are diagrams continued from FIG. 33 and showing computer graphics, and FIG. 34(E) shows the case of a 60-degree turn, FIG. 34(F) shows the case of a 75-degree turn, and FIG. 34(G) shows the case of a 90-degree turn;

FIG. 35 shows three-dimensional computer graphics showing a void analysis result for a three-dimensional CT image of a sample (No. 41) shown in table 23;

FIG. 36 shows three-dimensional computer graphics showing void analysis results for three-dimensional CT images of samples shown in table 24, and FIG. 36(A) shows the case of a sample of No. 50 in table 24, FIG. 36(B) shows the case of a sample of No. 51 in table 24, FIG. 36(C) shows the case of a sample of No. 52 in table 24, FIG. 36(D) shows the case of a sample of No. 53 in table 24, FIG. 36(E) shows the case of a sample of No. 54 in table 24, and FIG. 36(F) shows the case of a sample of No. 55 in table 24; and

FIG. 37 is a schematic diagram showing an application example of a damage evaluation apparatus according to Embodiment 2 of the present invention.

### BEST MODE FOR CARRYING OUT THE INVENTION

Embodiments of the present invention will be described in detail below with reference to the drawings.

### Embodiment 1

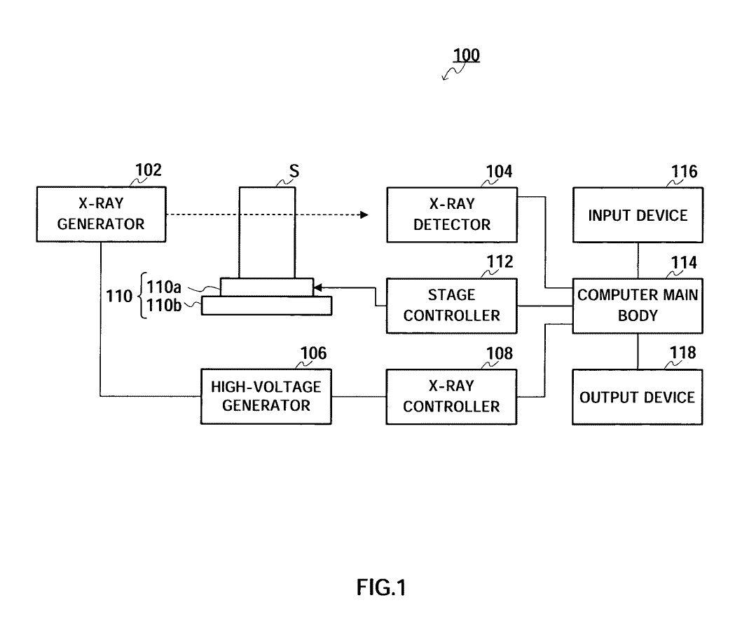

FIG. 1 is a block diagram showing a configuration of a damage evaluation apparatus according to Embodiment 1 of the present invention.

Damage evaluation apparatus 100 shown in FIG. 1 includes an X-ray CT (computerized tomography) apparatus and has, for example, X-ray generator 102, X-ray detector 104, high-voltage generator 106, X-ray controller 108, stage 110, stage controller 112, computer main body 114, input device 116 and output device 118. Input device 116 is a keyboard, a mouse, or a control panel, for example, and is operated by a user. Output device 118 is a display or a printer, for example.

X-ray generator 102 generates an X-ray and irradiates the generated X-ray onto sample S. X-ray generator 102 includes an X-ray tube, for example.

X-ray detector 104 detects an X-ray transmitted through sample S. X-ray detector 104 includes a CCD camera, for example. Though not shown, an X-ray spreads conically with a focal point of X-ray generator 102 being the center (cone beam), and therefore an X-ray transmitted through sample S is magnified and projected onto a detection surface of X-ray detector 104. Data of this projected image is sent to computer main body 114 as CT scan data of sample S.

High-voltage generator 106 supplies a high voltage to X-ray generator 102. High-voltage generator 106 includes a high-output voltage amplifier, for example.

X-ray controller 108 is connected to high-voltage generator 106 and controls an output voltage of high-voltage generator 106 and thereby adjusts the intensity of an X-ray generated by X-ray generator 102.

Stage 110 fixes sample S. Specifically, sample S is placed on stage 110. Stage 110 includes, for example, turntable 110a and base 110b that supports turntable 110a. A CT image requires projection data of the entire perimeter of sample S, and therefore, in damage evaluation apparatus 100, sample S is turned 360 degrees or 180 degrees by turntable 110a, projection data for each minute angle (for example, 1 degree) is detected by X-ray detector 104, and the data is recorded as CT scan data in computer main body 114.

Stage controller 112 controls the drive of turntable 110a. Specifically, upon measuring damage to sample S, as described above, turntable 110a is turned 360 degrees in steps of 1 degree, for example.

X-ray detector 104, X-ray controller 108 and stage controller 112 are connected to computer main body 114.

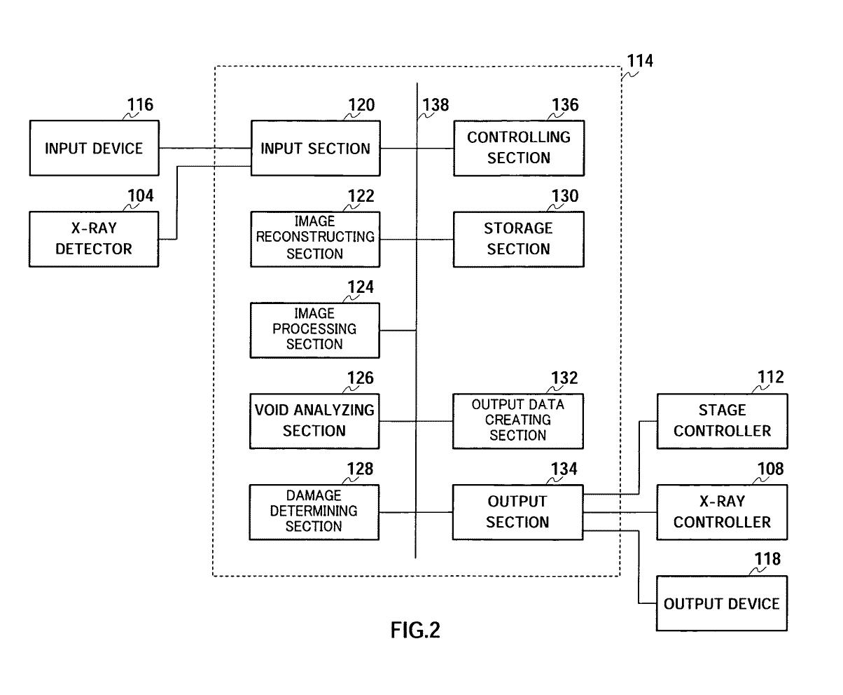

FIG. 2 is a block diagram showing a configuration of computer main body 114.

Computer main body 114 has input section 120, image reconstructing section 122, image processing section 124, void analyzing section 126, damage determining section 128, storage section 130, output data creating section 132, output section 134, controlling section 136 and bus 138. Storage section 130 has, though not shown, for example, a ROM that stores a program and data, and a RAM that temporarily stores data. The ROM may be a flash memory in which content is electrically rewritable. Controlling section 136 is connected to each of the sections 120 to 134 via bus 138 and performs overall control of the sections 120 to 134.

Input section 120 has a function as an interface that connects X-ray detector 104 and input device 116 to computer main body 114. Input section 120 performs input processing on CT scan data (that is, a projected image of an X-ray transmitted through sample S) outputted from X-ray detector 104 and operation data (that is, an operation signal by a user) outputted from input device 116 and converts the data into a computer processable data format.

Image reconstructing section 122 performs image reconstruction processing using CT scan data from X-ray detector 104 and creates data of multiple slice images of a sample which is obtained by reconstructing an internal state of sample S and which is necessary to create a three-dimensional image in image processing section 124.

Image processing section 124 creates, by a volume rendering technique, for example, three-dimensional image data (three-dimensional CT image) of the sample using the slice image data obtained by image reconstructing section 122. A three-dimensional image of the sample is sliced in various directions to check an internal state of the sample, and cross-sectional image data of the internal state can be created. A slice direction (section) can be freely set by a user.

Void analyzing section 126 calculates, by a predetermined calculation algorithm, quantitative data of the internal state of sample S, specifically, for example, the size and location of a void and the size and direction of a crack between voids, using the data of multiple slice images created by image reconstructing section 122. In addition, based on calculated information (the size and location of a void and the size and direction of a crack between voids), void analyzing section 126 calculates, for example, for all voids, how many other adjacent voids are connected to a given void (the void) and the ratio of the width of a crack between the void and another void to the width of the void. By this means, an void ratio, a void distribution state, a void continuing state, and the like, can be quantitatively learned.

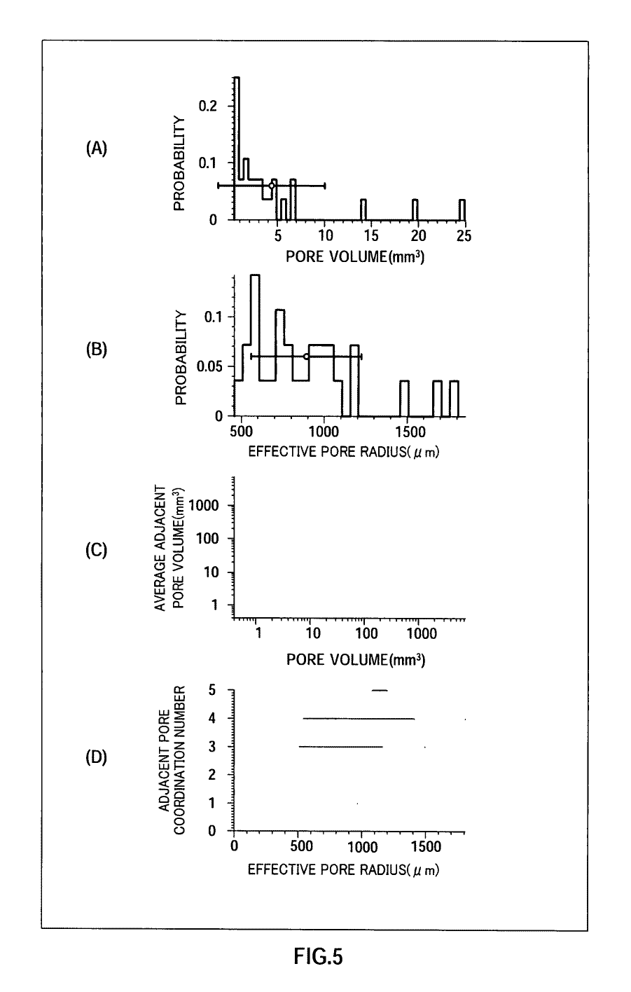

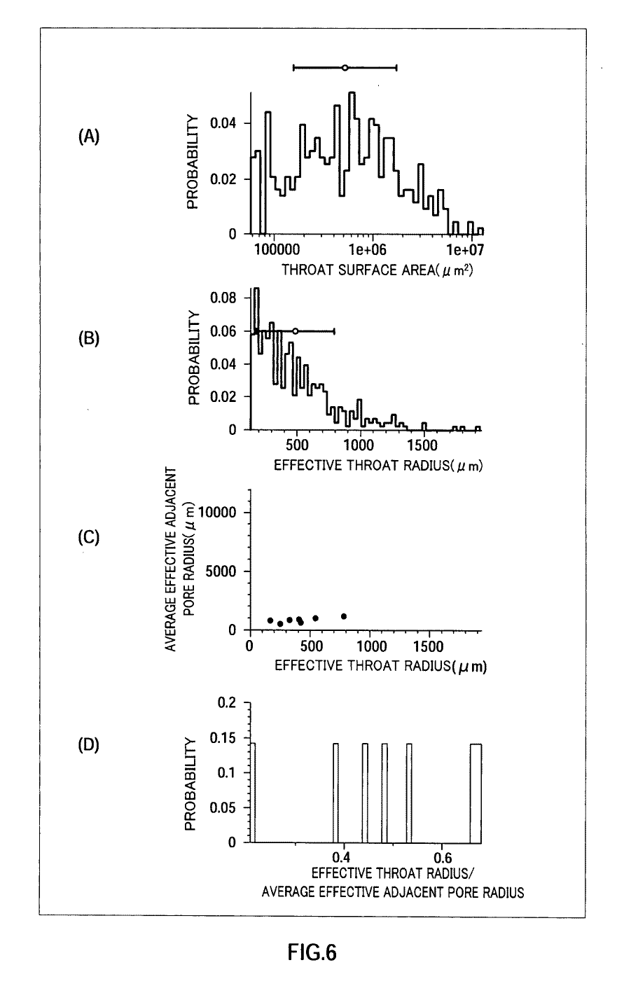

Here, as an example, a specific example of analysis results of void analyzing section 126 will be described using FIGS. 5 and 6, as will be described later, for example. Here, a “void” is referred to as a “pore”, and a “throat” refers to a narrow point of a portion (crack) connecting pores, and a plane of the thinnest portion of the point is defined as a “throat”.

In a graph of FIG. 5(A), a horizontal axis represents the volume of a nodal pore (hereinafter, referred to as the “pore volume”) (mm³), and a vertical axis represents probability, and the graph shows a distribution by pore volume (that is, the proportion of pores with a given volume in all pores).

In a graph of FIG. 5(B), a horizontal axis represents the effective radius of a nodal pore (hereinafter, referred to as the “effective pore radius”) (μm), and a vertical axis represents probability and the graph shows a distribution of effective radii, the effective radius being a radius for the case where pores of various shapes are made into spherical pores with the same volume.

In a graph of FIG. 5(C), a horizontal axis represents the pore volume (mm³), and a vertical axis represents the average volume of a pore adjacent to a focused pore (located on the horizontal axis) (hereinafter, referred to as the “average adjacent pore volume”) (mm³), and the graph shows a relationship between the sizes of adjacent pores.

In a graph of FIG. 5(D), a horizontal axis represents the effective pore radius (μm), and a vertical axis represents the number of pores adjacent to a focused pore (located on the horizontal axis) (hereinafter, referred to as the “adjacent pore coordination number”). By this graph, it can be found how many pores, by effective radius, are connected to a pore.

In a graph of FIG. 6(A), a horizontal axis represents the area of a throat (hereinafter, referred to as the “throat surface area”) (μm²), and a vertical axis represents probability, and the graph shows a distribution by throat surface area (that is, the proportion of throats with a given surface area in all throats).

In a graph of FIG. 6(B), a horizontal axis represents the effective radius of a throat (hereinafter, referred to as the “effective throat radius”) (μm), and a vertical axis represents probability, and the graph shows a distribution of effective radii, the effective radius being a radius for the case where throats of various shapes are made into spherical throats with the same area.

In a graph of FIG. 6(C), a horizontal axis represents the effective throat radius (μm), and a vertical axis represents the average effective radius of two pores located on both sides of a focused throat (located on the horizontal axis), that is, two pores adjacent to the throat, (hereinafter, referred to as the “average effective adjacent pore radius”) (μm). By this graph, a relationship between the sizes of a throat and pores adjacent thereto can be found.

In a graph of FIG. 6(D), a horizontal axis represents the ratio of an effective throat radius to an average effective adjacent pore radius (effective throat radius/average effective adjacent pore radius), and a vertical axis represents probability. By this graph, it can be found how thin a throat is with respect to a pore.

In this way, the graphs shown in FIGS. 5(A) to (D) provide information of avoid (pore), and the graphs shown in FIGS. 6(A) to (D) provide information of a throat which is a portion (crack) connecting pores. Specifically, FIGS. 5(A) to (D) respectively show the distribution conditions of the volumes of pores, the distribution conditions of the effective radii of pores, an average value of the volume of adjacent pores between adjacent pores, and the number of adjacent pores between adjacent pores (how many pores, by effective radius, are connected to a given pore). FIGS. 6(A) and (B) respectively show the distribution conditions of the cross-sectional areas of throats and the distribution conditions of the effective radii of throats. FIG. 6(C) shows a relationship between an effective throat radius and an average effective adjacent pore radius, and FIG. 6(D) shows, based on the ratio of an effective throat radius to an average effective adjacent pore radius, how throats, from thick throats to thin throats, are distributed with respect to a pore.

Damage determining section 128 determines, using analysis results of void analyzing section 126, a damage state, that is, the presence or absence and degree of damage, for each type, according to a predetermined determination criterion.

For example, as an example, the following determination criteria (1) to (3) can be used.

(1) It is estimated that when the number of other adjacent voids connected to the void (see FIG. 5(D)) is larger (for example, eight or more), the number of cracks becomes larger, and thus, it is determined that damage is large.

(2) When the ratio (see FIG. 6(D)) of the width of a crack between the void and another void to the width of the void is not fixed, but gradually decreases, the crack has various widths, and thus, it is determined that damage is large.

(3) In the case of a pavement, for example, when looking at information from the side of a three-dimensional void distribution, a crack occurs in a vertical direction, and therefore, when a crack and pores are connected between an upper surface and a lower surface, it means that the crack penetrates from the upper surface to the lower surface, and thus, it is determined that damage is large.

Output data creating section 132 creates numeric value files and graphics data of computer calculation results (for example, processing results of image reconstructing section 122, image processing section 124, void analyzing section 126 and damage determining section 128).

Output section 134 has a function as an interface that connects external X-ray controller 108, stage controller 112 and output device 118 to computer main body 114. Output section 134 outputs control instructions for X-ray controller 108 and stage controller 112 which are created by controlling section 136, and outputs the numeric value files and graphics data created by output data creating section 132 to output device (a display, a printer, or the like) 118. The numeric value files and graphics data outputted to output device 118 are displayed on a screen or printed on a paper.

In the present embodiment, as described above, by utilizing an X-ray CT apparatus, image is reconstructed using projected images of an X-ray transmitted through a sample, and a three-dimensional image of an internal state of the sample is constructed. Therefore, high resolution (for example, substantially 30 μm) is obtained, and an internal state, for example, the state of voids (for example, quantitative data of an void ratio, avoid distribution state, avoid continuing state, and the like), can be accurately learned. As such, an internal state is quantitatively learned using three-dimensional image data of the inside of a sample, so that an internal damage state can be accurately evaluated by appropriately setting an evaluation criterion.

To be more specific, voids in an object are independent or continuous, for example, and therefore measurement of voids is generally difficult. Hence, in the present embodiment, first, two-dimensional images of the inside of an object are read using an X-ray, and, after the images are superimposed to construct a three-dimensional image, voids are analyzed using the obtained three-dimensional image. For example, the continuity of a crack between voids is read using the obtained three-dimensional image, and, when a given void is connected to other four, five or more voids, particularly, when the given void is connected to other eight or nine voids, it is appropriate to consider that there is a crack. This is because in a new asphalt mixture or the like, such a connection is not found. When the ratio of the size of a crack to the size of a void is fixed, the proportion between the crack and the void is always fixed, and thus, an asphalt mixture or the like is sound. However, when this ratio changes, voids are connected to each other, and thus, there is a crack. For example, according to actual measurement, in the case of an asphalt pavement, even in the case of summertime with a number of passing vehicles of 600 per day, a crack occurs inside. Therefore, there is a threshold value for the presence of a crack.

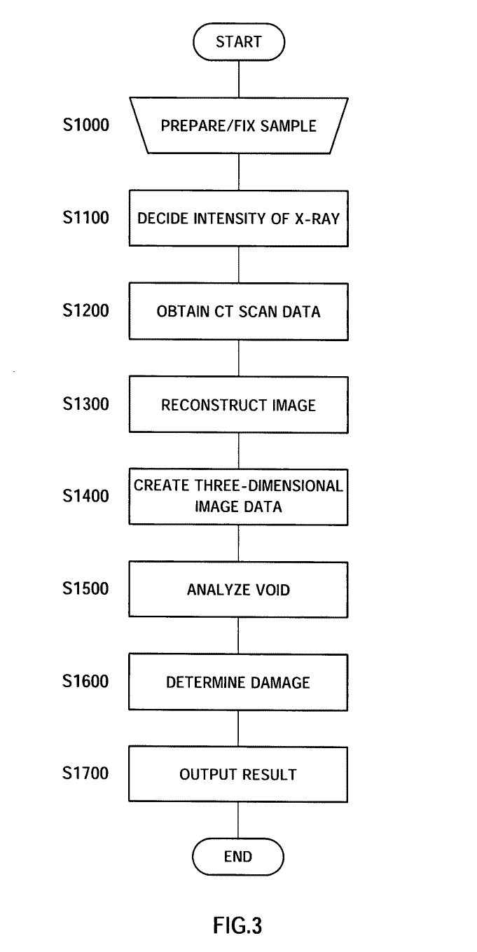

Next, the operation of damage evaluation apparatus 100 having the above-described configuration will be described using a flowchart shown in FIG. 3. The flowchart shown in FIG. 3 is stored in advance in storage section 130 (for example, a ROM) as a control program, and is performed by controlling section 136.

First, in step S1000, a sample is prepared and fixed. Specifically, a user prepares sample S, by a cut or the like, from an asphalt mixture or the like which is the target of damage evaluation. For example, as sample S, in the case of an asphalt mixture, a sample with a thickness of 2 to 5 cm and a length of less than 20 cm is prepared, and, in the case of a cement concrete mixture, a sample with a thickness of 2 to 3 cm and a length of less than 20 cm is prepared. Then, the prepared sample S is placed and fixed on stage 110 of damage evaluation apparatus (X-ray CT apparatus) 100.

Then, in step S1100, the intensity of an X-ray to be irradiated onto sample S is decided. Specifically, the intensity of an X-ray is decided so that the X-ray transmits through sample S, by irradiating an X-ray onto sample S onstage 110 and observing whether the irradiated X-ray transmits through sample S.

Then, in step S1200, stage 110 (particularly, turntable 110a) is turned, and CT scan data of sample S is obtained. Specifically, with the X-ray intensity decided in step S1100, irradiation of an X-ray is performed with stage 110 being turned 360 degrees in steps of 1 degree, for example, projection data for each 1 degree is detected by X-ray detector 104, and the data is recorded as CT scan data in computer main body 114.

Then, in step S1300, image reconstructing section 122 creates data of multiple reconstructed slice images of the inside of sample S. Specifically, images are reconstructed using the CT scan data (two-dimensional image data) collected in step S1200, and reconstructed slice image data of an internal state of sample S is created.

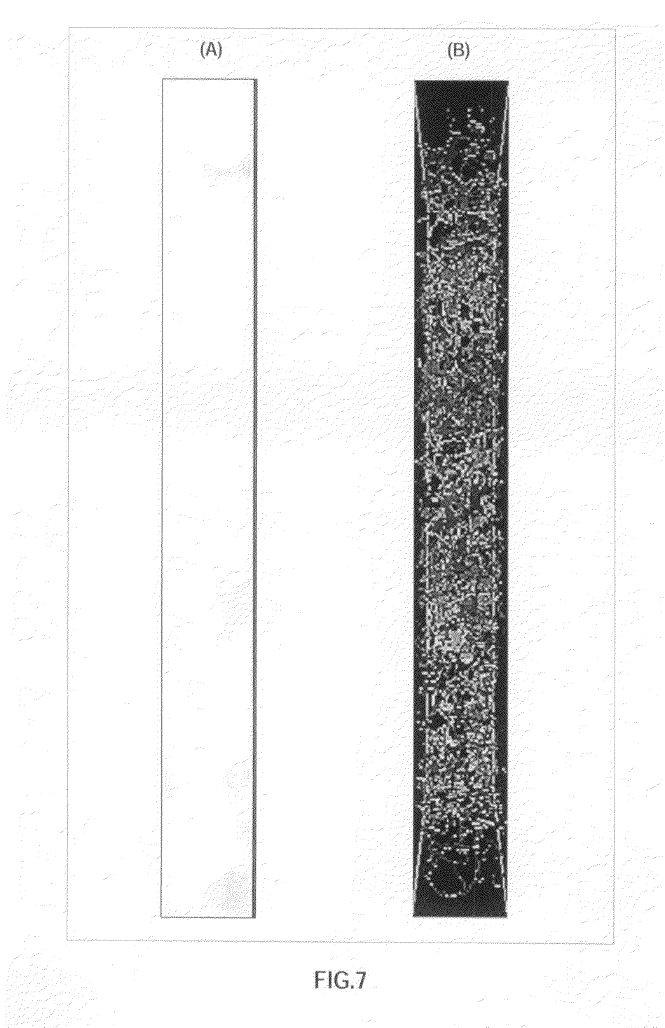

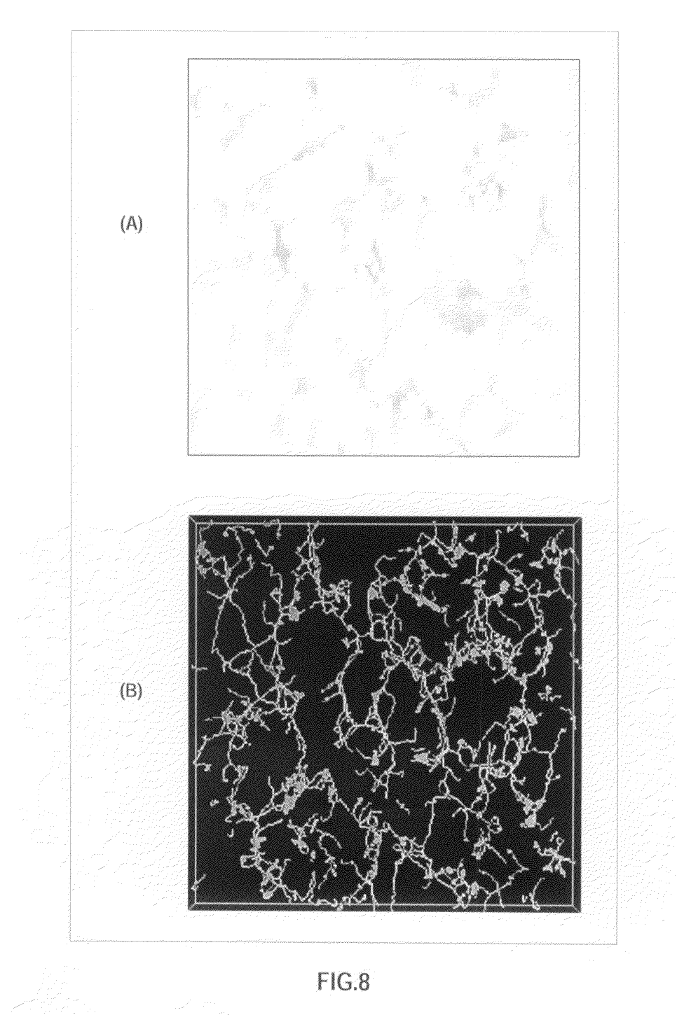

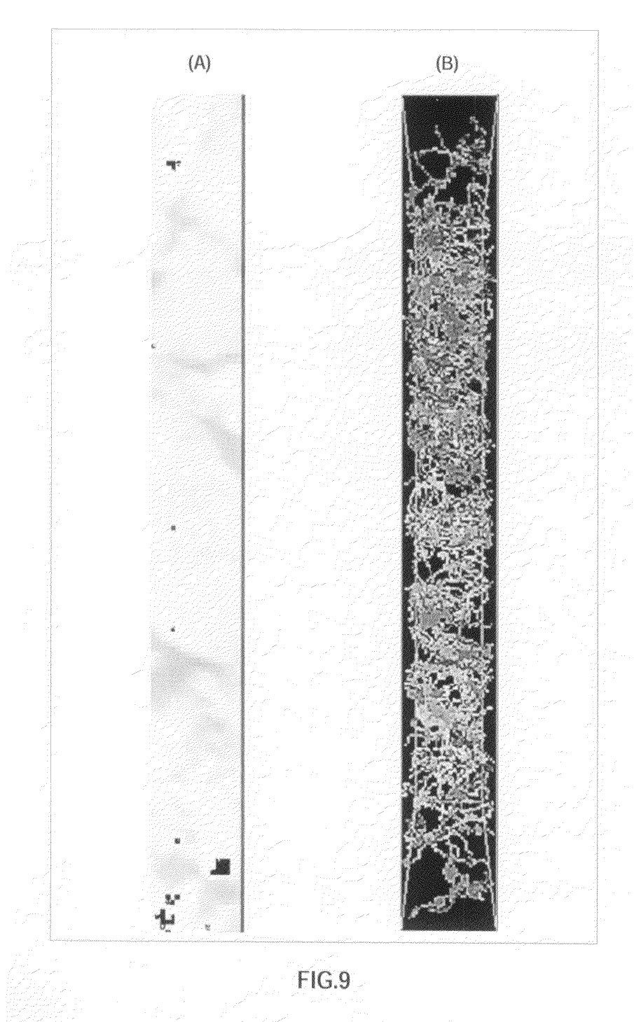

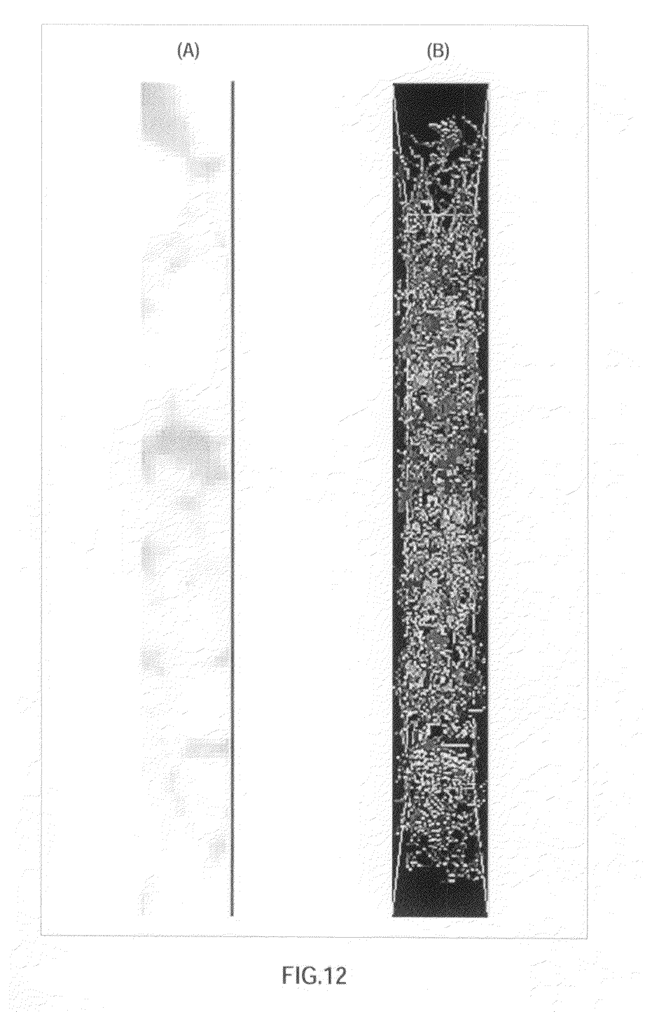

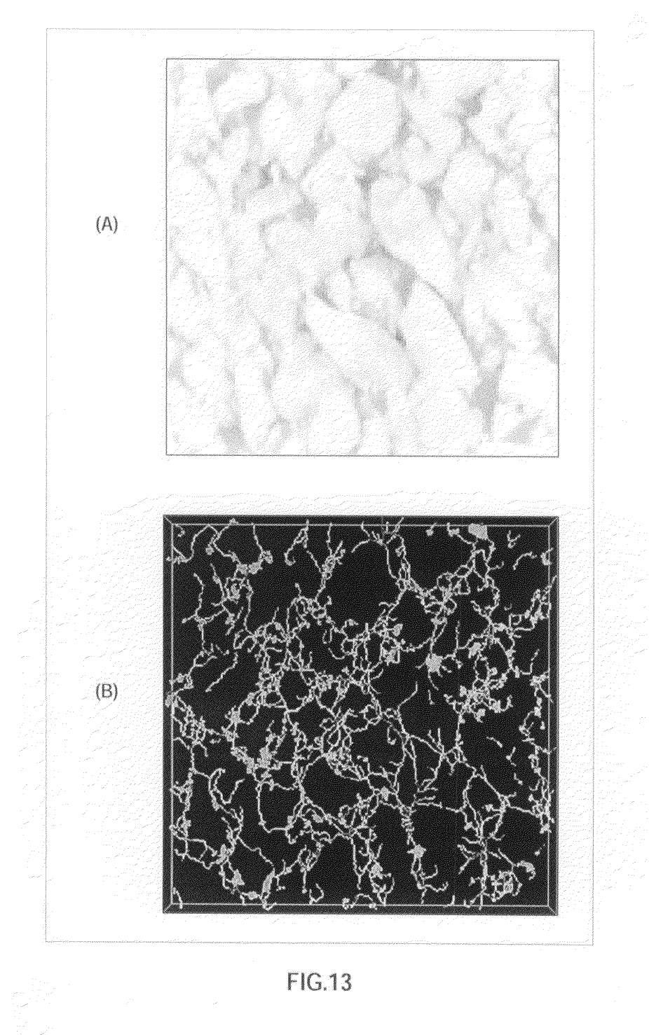

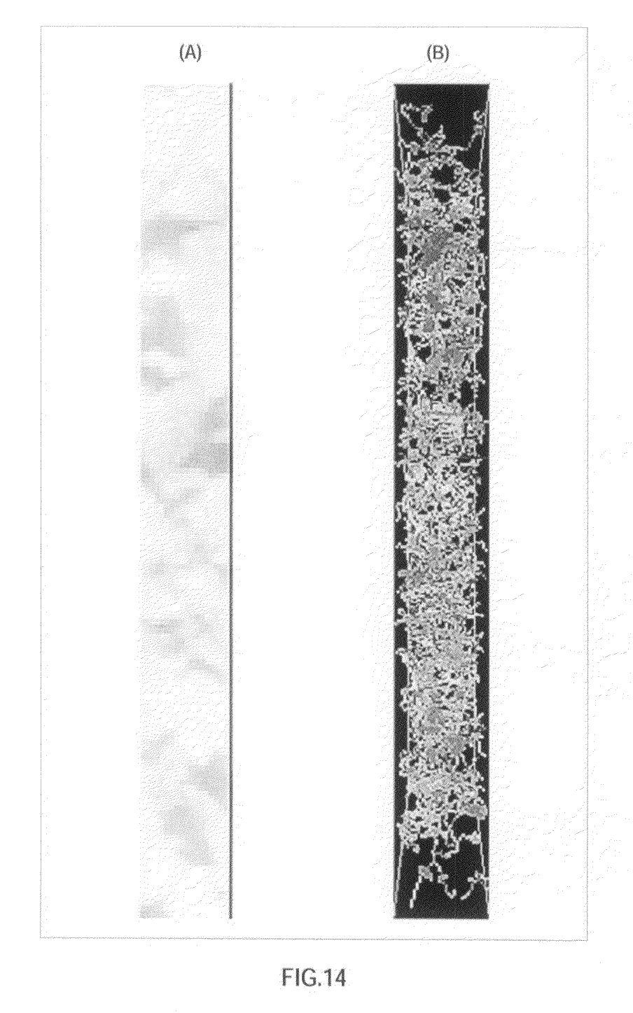

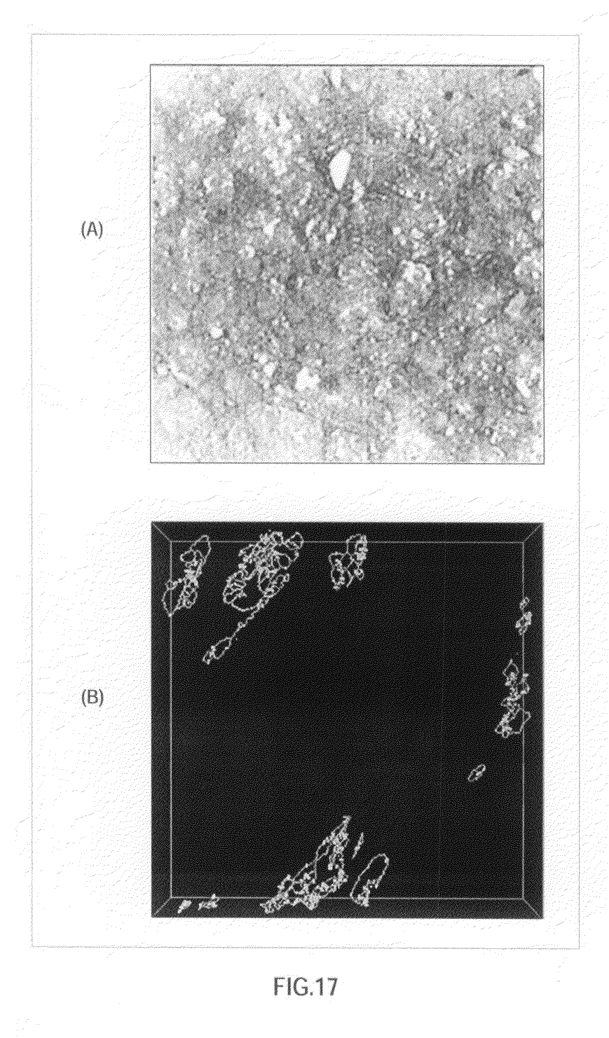

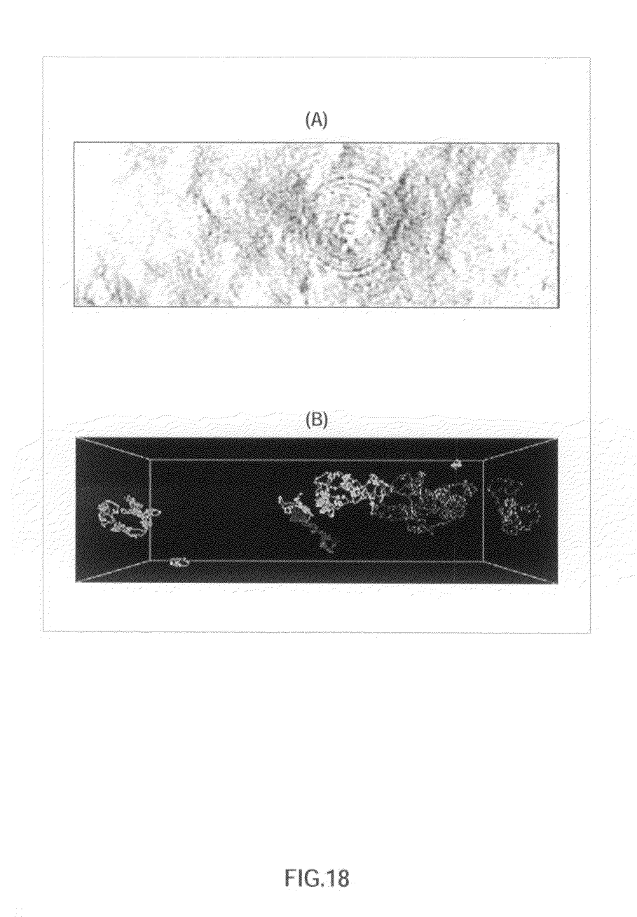

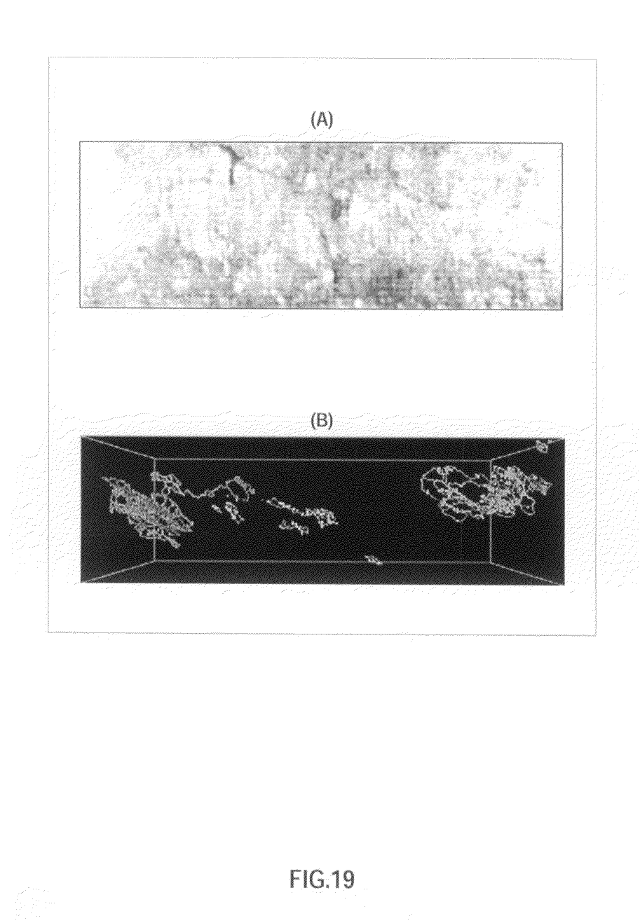

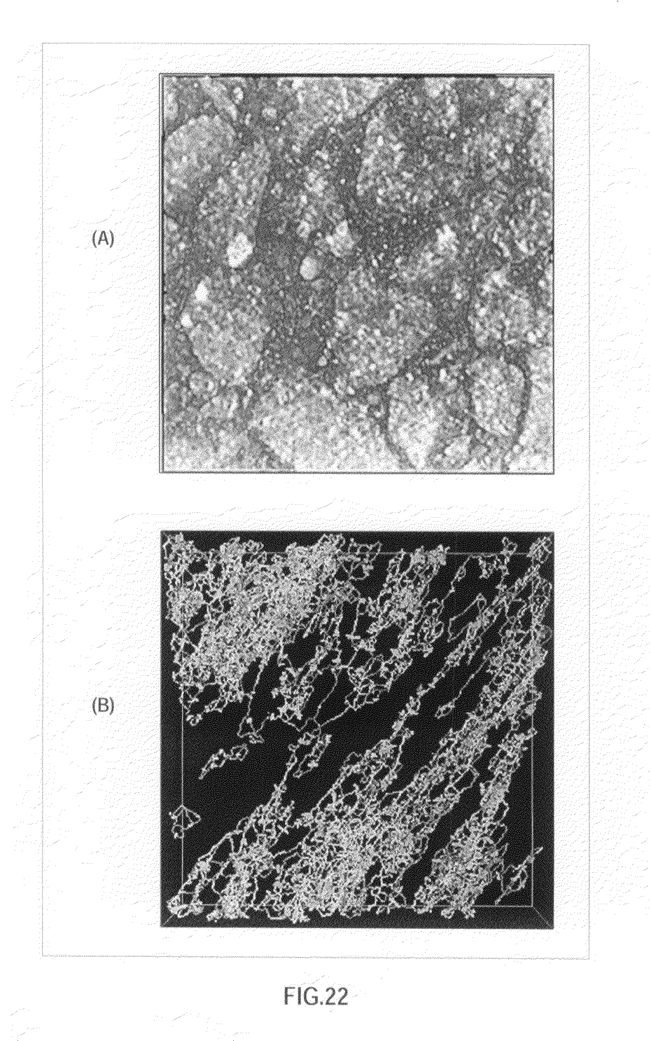

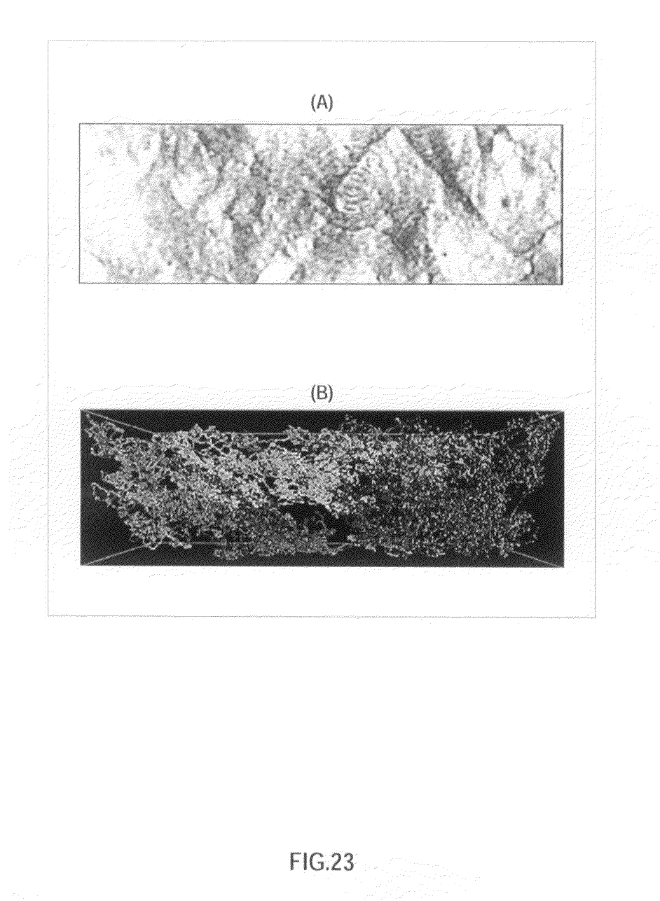

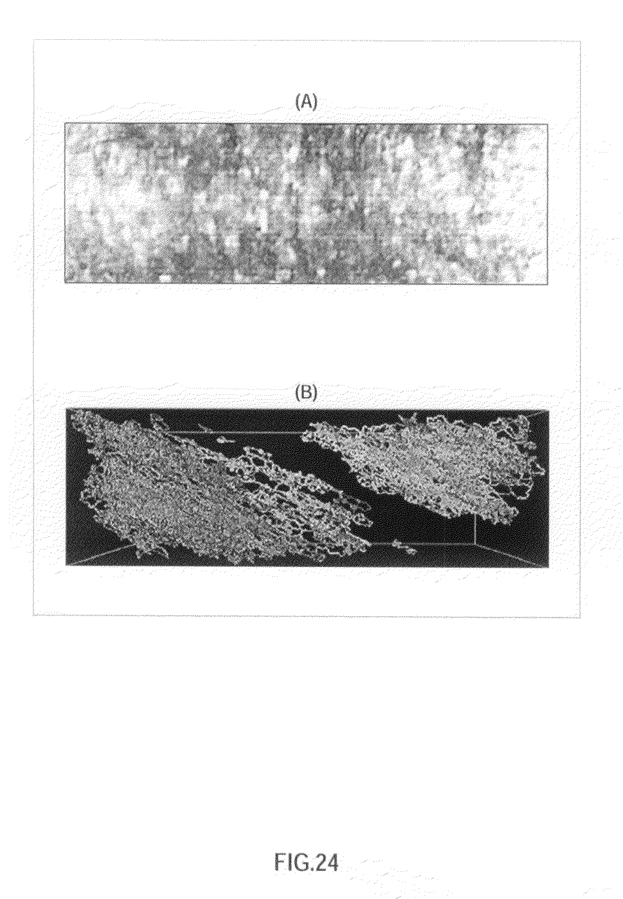

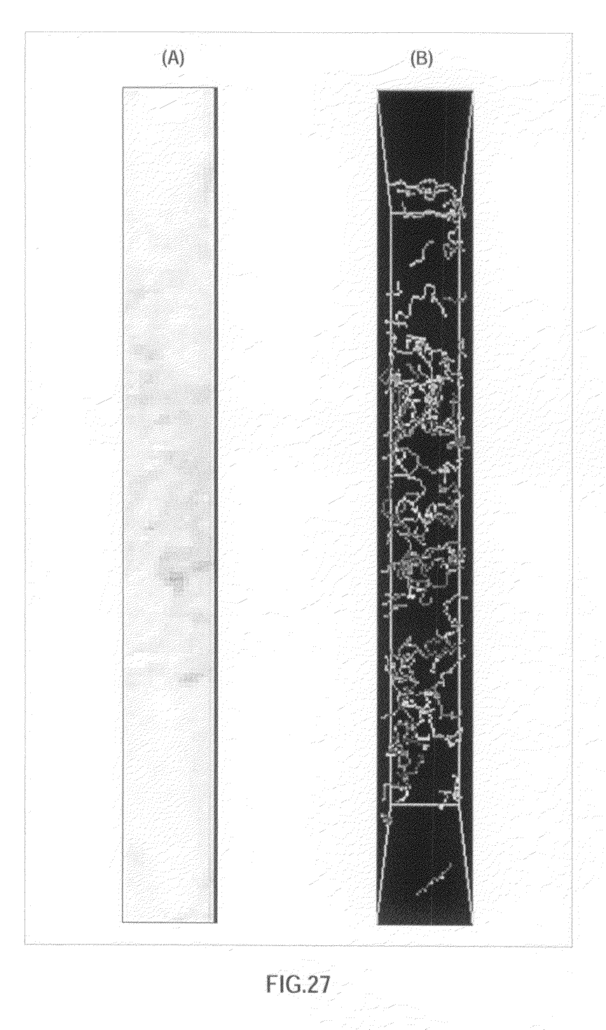

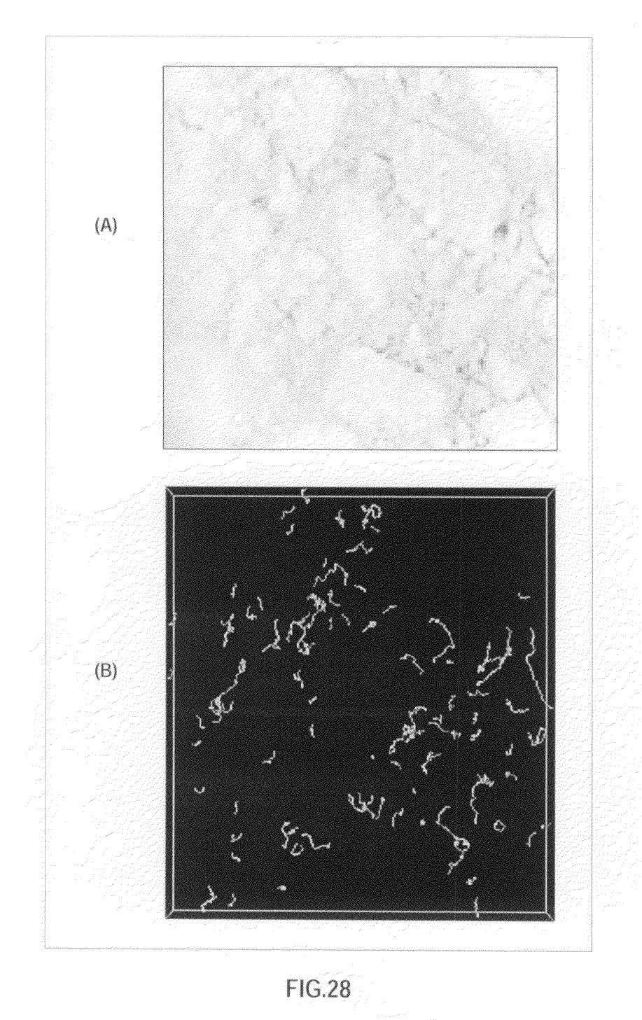

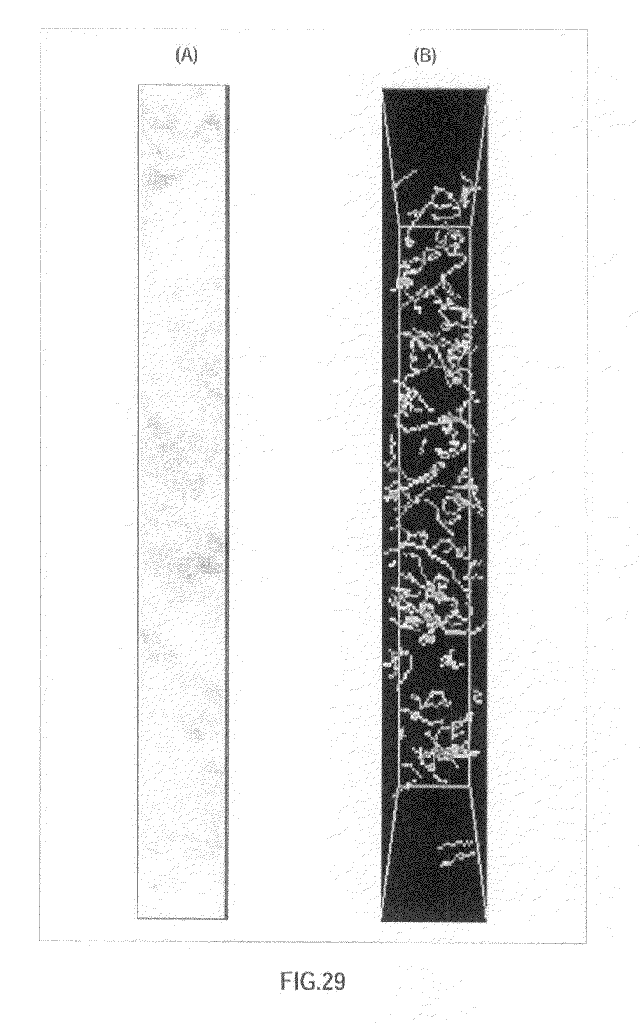

Then, in step S1400, image processing section 124 creates three-dimensional image data of the sample. Specifically, by using the slice image data created in step S1300, three-dimensional image data (three-dimensional CT image) of the sample is created by a volume rendering technique, for example. For example, as examples of a three-dimensional CT image, see FIG. 7(A), FIG. 8(A), FIG. 9(A), FIG. 12(A), FIG. 13(A), FIG. 14(A), FIG. 17(A), FIG. 18(A), FIG. 19(A), FIG. 22(A), FIG. 23(A), FIG. 24(A), FIG. 27(A), FIG. 28(A) and FIG. 29(A), as will be described later.

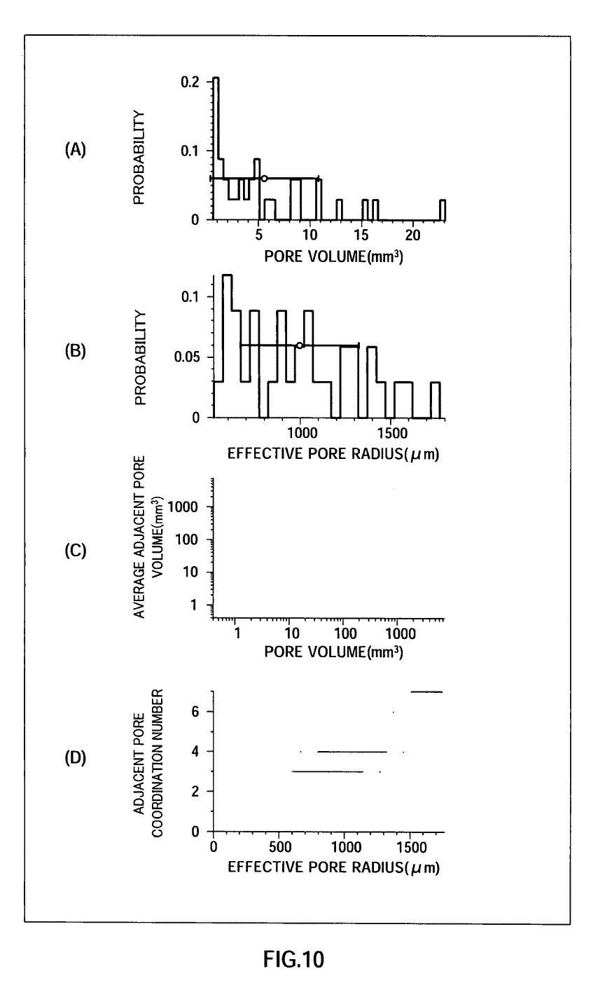

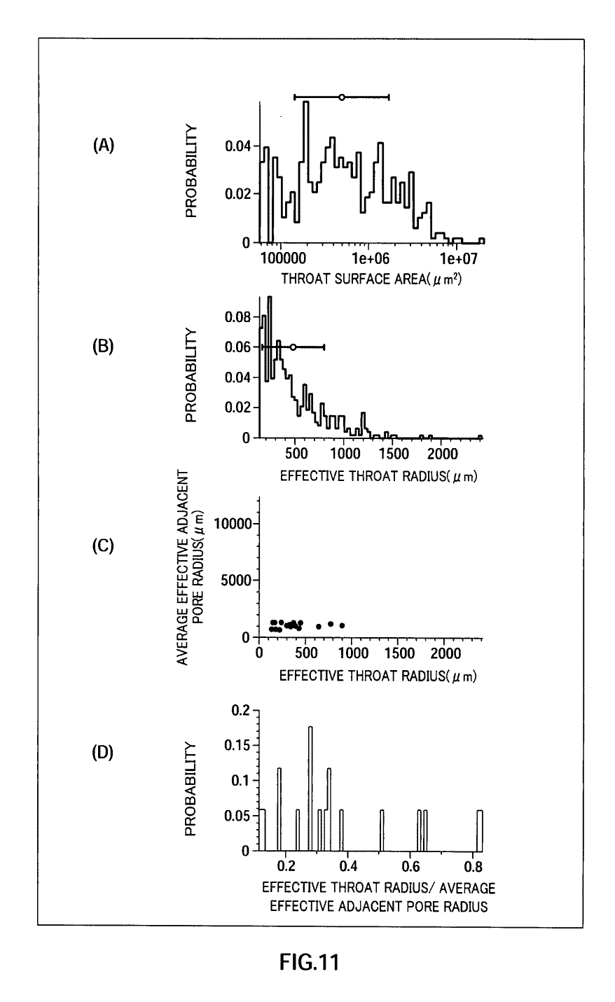

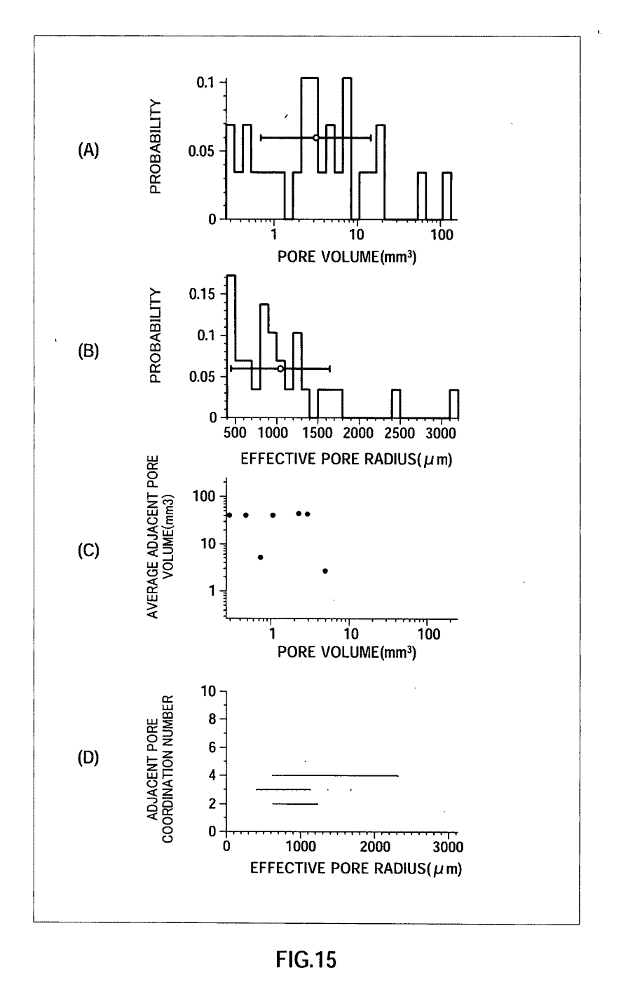

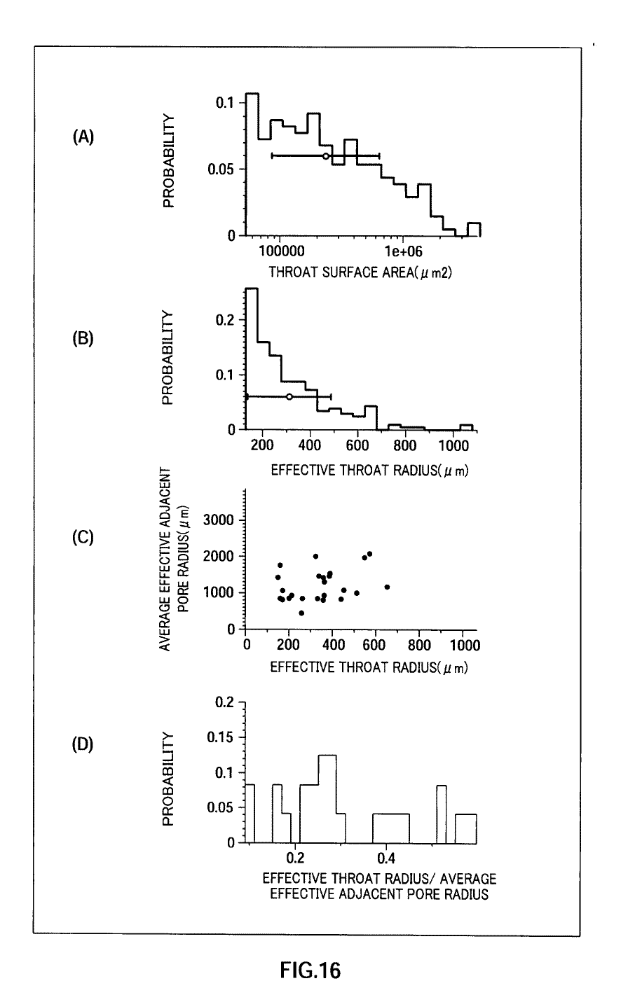

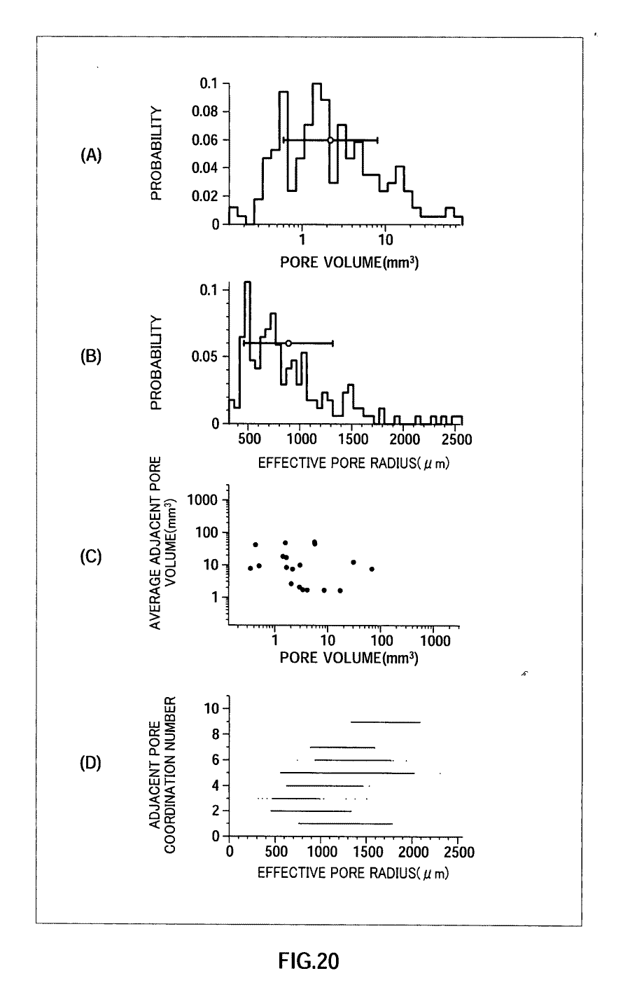

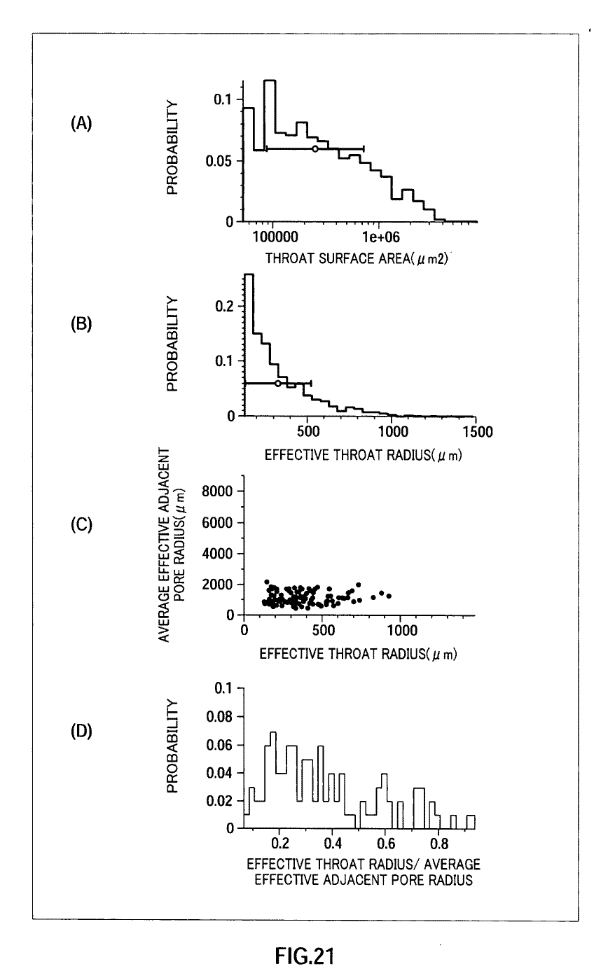

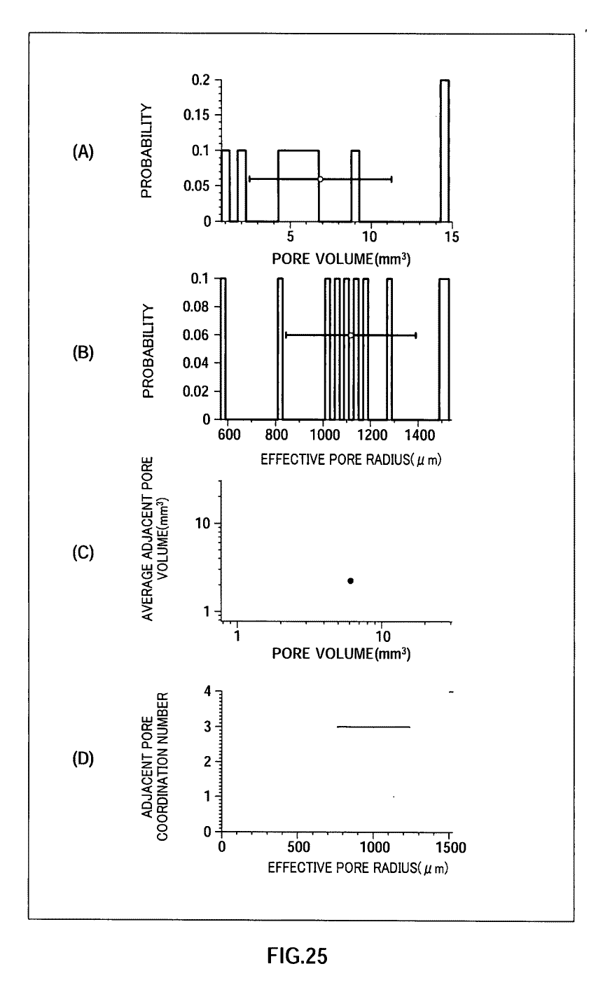

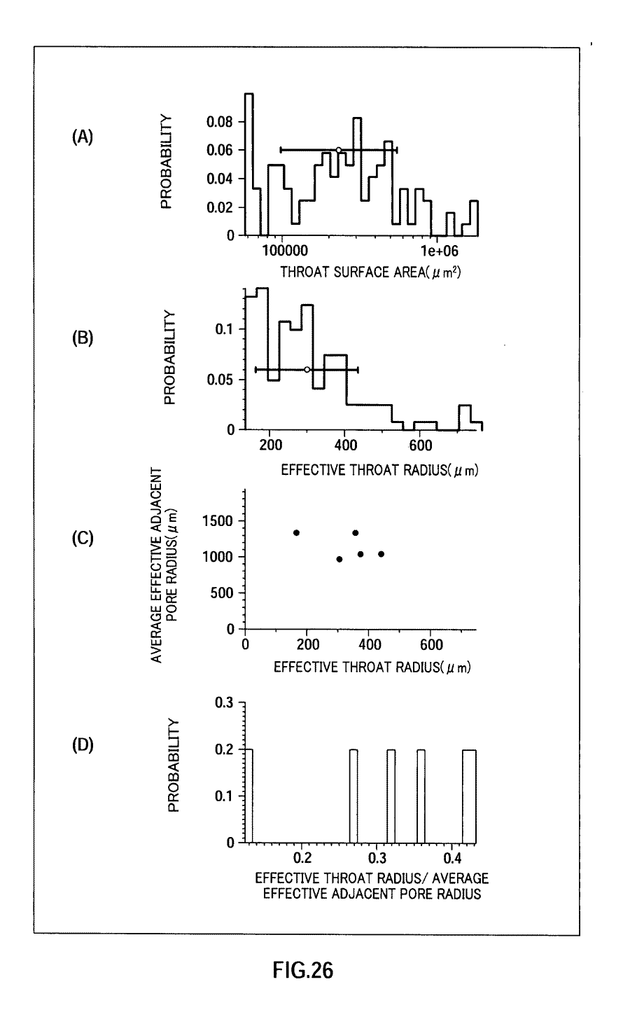

Then, in step S1500, void analyzing section 126 analyzes voids. Specifically, quantitative data of the internal state of sample S, for example, the size and location of a void and the size and direction of a crack between voids, is calculated using the data of multiple reconstructed slice images of the inside of sample S which is created in step S1300. In addition, based on this information (the size and location of a void and the size and direction of a crack between voids), for example, for all voids, how many other adjacent voids are connected to a given void (the void) and the ratio of the width of a crack between the void and another void to the width of the void, are calculated. For example, as examples of void analysis results, see FIGS. 5(A) to (D), FIGS. 6(A) to (D), FIG. 7(B), FIG. 8(B), FIG. 9(B), FIGS. 10(A) to (D), FIGS. 11(A) to (D), FIG. 12(B), FIG. 13(B), FIG. 14(B), FIGS. 15(A) to (D), FIGS. 16(A) to (D), FIG. 17(B), FIG. 18(B), FIG. 19(B), FIGS. 20(A) to (D), FIGS. 21(A) to (D), FIG. 22(B), FIG. 23(B), FIG. 24(B), FIGS. 25(A) to (D), FIGS. 26(A) to (D), FIG. 27(B), FIG. 28(B) and FIG. 29(B), as will be described later.

Then, in step S1600, damage determining section 128 determines damage. Specifically, by using void analysis results obtained in step S1500, a damage state, that is, the presence or absence and degree of damage, is determined for each type, according to a predetermined determination criterion, for example, the above-described determination criteria (1) to (3).

Then, in step S1700, computer calculation results (for example, processing results of image reconstructing section 122, image processing section 124, void analyzing section 126 and damage determining section 128) are outputted to external output device 118. Specifically, for example, numeric value files and graphics data which are processing results in step S1300 (image reconstructing section 122), processing results in step S1400 (image processing section 124), processing results in step S1500 (void analyzing section 126), and processing results in step S1600 (damage determining section 128), are outputted to output device (a display, a printer, or the like) 118 by an instruction from (selection by) the user. As a result, the numeric value files and graphics data outputted to output device 118 are displayed on a screen or printed on a paper.

At this time, it is preferable to provide, when detected cavities (pores) and/or cracks (throats) are outputted (displayed or printed), predetermined colors according to sizes of the cavities and/or cracks. As a result, the user can visually very easily check the sizes, locations and distribution states of the cavities and/or cracks. For example, as examples of display of the void analysis results, see FIG. 7(B), FIG. 8(B), FIG. 9(B), FIG. 12(B), FIG. 13(B), FIG. 14(B), FIG. 17(B), FIG. 18(B), FIG. 19(B), FIG. 22(B), FIG. 23(B), FIG. 24(B), FIG. 27(B), FIG. 28(B) and FIG. 29(B), as will be described later.

In a word, processing steps are roughly as follows when described using a pavement as an example.

1) Sample S for each layer of a pavement is prepared.

2) Sample S is placed in damage evaluation apparatus (X-ray CT apparatus) 100, and a three-dimensional CT image is obtained.

3) By using the obtained three-dimensional CT image, quantitative data of an internal state of sample S is calculated by a predetermined calculation algorithm.

4) By using the obtained quantitative data, a damage state of the pavement is determined by a predetermined evaluation criterion (threshold value).

Now, a specific example for the case where the present damage evaluation apparatus 100 is applied to an asphalt pavement will be described.

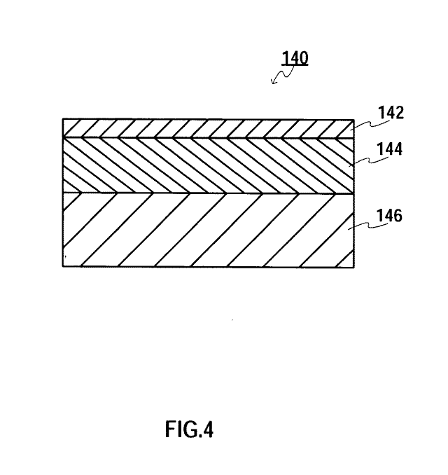

FIG. 4 shows a pavement configuration of an asphalt pavement. As shown in FIG. 4, asphalt layer 140 generally has a three-layer structure including surface course 142, base course 144 and treatment course 146.

FIGS. 5 to 9 show void analysis results for a sample of an upper portion of surface course 142 of a new drainage mixture. More specifically, FIG. 5(A) is a graph showing a distribution by pore volume, FIG. 5(B) is a graph showing a distribution of the effective radii of pores, FIG. 5(C) is a graph showing a relationship between the sizes of adjacent pores, and FIG. 5(D) is a graph showing how many pores, by effective radius, are connected to a pore. FIG. 6(A) is a graph showing a distribution by throat area, FIG. 6(B) is a graph showing a distribution of the effective radii of throats, FIG. 6(C) is a graph showing a relationship between the sizes of a throat and pores adjacent thereto, and FIG. 6(D) is a graph showing how thin a throat is with respect to a pore. FIG. 7(A) is a plane view of a three-dimensional CT image, and FIG. 7(B) shows three-dimensional computer graphics showing a void analysis result for the three-dimensional CT image in FIG. 7(A). FIG. 8(A) is a side view of a three-dimensional CT image, and FIG. 8(B) shows three-dimensional computer graphics showing a void analysis result for the three-dimensional CT image in FIG. 8(A). FIG. 9(A) is a front view of a three-dimensional CT image, and FIG. 9(B) shows three-dimensional computer graphics showing a void analysis result for the three-dimensional CT image in FIG. 9(A).

On the other hand, FIGS. 10 to 14 show void analysis results for a sample of a lower portion of surface course 142 of the new drainage mixture. More specifically, FIG. 10(A) is a graph showing a distribution by pore volume, FIG. 10(B) is a graph showing a distribution of the effective radii of pores, FIG. 10(C) is a graph showing a relationship between the sizes of adjacent pores, and FIG. 10(D) is a graph showing how many pores, by effective radius, are connected to a pore. FIG. 11(A) is a graph showing a distribution by throat area, FIG. 11(B) is a graph showing a distribution of the effective radii of throats, FIG. 11(C) is a graph showing a relationship between the sizes of a throat and pores adjacent thereto, and FIG. 11(D) is a graph showing how thin a throat is with respect to a pore. FIG. 12(A) is a plane view of a three-dimensional CT image, and FIG. 12(B) shows three-dimensional computer graphics showing a void analysis result for the three-dimensional CT image in FIG. 12(A). FIG. 13(A) is a side view of a three-dimensional CT image, and FIG. 13(B) shows three-dimensional computer graphics showing a void analysis result for the three-dimensional CT image in FIG. 13(A). FIG. 14(A) is a front view of a three-dimensional. CT image, and FIG. 14(B) shows three-dimensional computer graphics showing a void analysis result for the three-dimensional CT image in FIG. 14(A).

FIGS. 15 to 19 show void analysis results for a sample of surface course 142 of an existing (five years after construction) coarse-graded type mixture. More specifically, FIG. 15(A) is a graph showing a distribution by pore volume, FIG. 15(B) is a graph showing a distribution of the effective radii of pores, FIG. 15(C) is a graph showing a relationship between the sizes of adjacent pores, and FIG. 15(D) is a graph showing how many pores, by effective radius, are connected to a pore. FIG. 16(A) is a graph showing a distribution by throat area, FIG. 16(B) is a graph showing a distribution of the effective radii of throats, FIG. 16(C) is a graph showing a relationship between the sizes of a throat and pores adjacent thereto, and FIG. 16(D) is a graph showing how thin a throat is with respect to a pore. FIG. 17(A) is a plan view of a three-dimensional CT image, and FIG. 17(B) shows three-dimensional computer graphics showing a void analysis result for the three-dimensional CT image in FIG. 17(A). FIG. 18(A) is a front view of a three-dimensional CT image, and FIG. 18(B) shows three-dimensional computer graphics showing a void analysis result for the three-dimensional CT image in FIG. 18(A). FIG. 19(A) is a side view of a three-dimensional CT image, and FIG. 19(B) shows three-dimensional computer graphics showing a void analysis result for the three-dimensional CT image in FIG. 19(A).

On the other hand, FIGS. 20 to 24 show void analysis results for a sample of base course 144 of an existing (ten years after construction) coarse-graded type mixture. More specifically, FIG. 20(A) is a graph showing a distribution by pore volume, FIG. 20(B) is a graph showing a distribution of the effective radii of pores, FIG. 20(C) is a graph showing a relationship between the sizes of adjacent pores, and FIG. 20(D) is a graph showing how many pores, by effective radius, are connected to a pore. FIG. 21(A) is a graph showing a distribution by throat area, FIG. 21(B) is a graph showing a distribution of the effective radii of throats, FIG. 21(C) is a graph showing a relationship between the sizes of a throat and pores adjacent thereto, and FIG. 21(D) is a graph showing how thin a throat is with respect to a pore. FIG. 22(A) is a plan view of a three-dimensional CT image, and FIG. 22(B) shows three-dimensional computer graphics showing avoid analysis result for the three-dimensional CT image in FIG. 22(A). FIG. 23(A) is a front view of a three-dimensional CT image, and FIG. 23(B) shows three-dimensional computer graphics showing a void analysis result for the three-dimensional CT image in FIG. 23(A). FIG. 24(A) is a side view of a three-dimensional CT image, and FIG. 24(B) shows three-dimensional computer graphics showing a void analysis result for the three-dimensional CT image in FIG. 24(A).

FIGS. 25 to 29 show void analysis results for a sample of a lower portion of a coarse-graded type mixture of new base course 144. More specifically, FIG. 25(A) is a graph showing a distribution by pore volume, FIG. 25(B) is a graph showing a distribution of the effective radii of pores, FIG. 25(C) is a graph showing a relationship between the sizes of adjacent pores, and FIG. 25(D) is a graph showing how many pores, by effective radius, are connected to a pore. FIG. 26(A) is a graph showing a distribution by throat area, FIG. 26(B) is a graph showing a distribution of the effective radii of throats, FIG. 26(C) is a graph showing a relationship between the sizes of a throat and pores adjacent thereto, and FIG. 26(D) is a graph showing how thin a throat is with respect to a pore. FIG. 27(A) is a plane view of a three-dimensional CT image, and FIG. 27(B) shows three-dimensional computer graphics showing a void analysis result for the three-dimensional CT image in FIG. 27(A). FIG. 28(A) is a side view of a three-dimensional CT image, and FIG. 28(B) shows three-dimensional computer graphics showing avoid analysis result for the three-dimensional CT image in FIG. 28(B). FIG. 29(A) is a front view of a three-dimensional CT image, and FIG. 29(B) shows three-dimensional computer graphics showing a void analysis result for the three-dimensional CT image in FIG. 29(A).

From these drawings, for example, the following findings can be obtained.

First, from FIG. 5(A), FIG. 10(A), FIG. 15(A), FIG. 20(A) and FIG. 25(A), the distribution of the sizes of the volumes of pores (voids) can be found, and thus, the characteristics of the mixture can be found. For example, comparing FIG. 5(A) with FIG. 10(A), both of them are for a new drainage mixture, and they respectively correspond to the upper and lower portions of the surface course of the same area. While in FIG. 5(A) there are many small pores, in FIG. 10(A), there are many large pores. By this means, it can be seen that, in this surface course, the compaction of the lower portion is not sufficient, and thus, there are many pores in the lower portion. This shows that the mixture is not homogeneously made.

On the other hand, comparing FIG. 6(A) with FIG. 11(A), it can be seen that for the distribution of throats (cracks) between pores, both of them have substantially the same cross-sectional area.

Comparing the radii of pores between FIG. 5(B) and FIG. 10(B), the average value indicated by a circle in the drawings differs between the two, and the average value is 900 μm in FIG. 5(B), and is 1000 μm in FIG. 10(B). It can also be seen that FIG. 10(B) has a larger number of large voids than FIG. 5(B).

On the other hand, comparing FIG. 6(B) with FIG. 11(B), both of them are substantially the same, and thus, it can be considered that the distribution of cracks is substantially the same between the two.

Comparing the volume of a given pore with the volume of a pore adjacent thereto between FIG. 15(C) showing five years after service of the surface course and FIG. 20(C) showing ten years after service of the base course, while in FIG. 15(C), an adjacent pore is extremely large with respect to a given pore, in FIG. 20(C), a given pore and an adjacent pore have a substantially one-to-one relationship, indicating that there is no sudden change in the size of voids.

Comparing FIG. 16(C) showing five years after service of the surface course with FIG. 21(C) showing ten years after service of the base course, while in FIG. 16(C), throats having radii substantially the same size as the radii of their adjacent pores are aligned (the shape is rectangular), in FIG. 21(C), the radii of pores adjacent to throats are not uniform and adjacent throats are larger (the shape is rectangular, but is long and thin rectangular). This shows that in FIG. 21(C), adjacent cracks have different sizes.

FIG. 25(D) showing a new base course and FIG. 20(D) showing ten years after service of an existing base course which is considered to have cracks show the relationship between the effective radius of a pore and the number of pores adjacent thereto, and thus, it can be said that, when the scale of the vertical axis is greater, the number of cracks developed from one void becomes larger. Therefore, it can be concluded that FIG. 20(D) has a larger number of cracks than FIG. 25(D).

In FIG. 21(D) showing ten years after service of an existing base course which is considered to have cracks, the curve gradually decreases when the relationship of the ratio of the effective radius of a throat to the effective radius of two pores adjacent thereto in the drawing becomes greater. However, in FIG. 26(D) showing a new base course, the relationship is fixed, and thus, it is considered that there is no crack.

Although, in the above specific examples, an asphalt pavement has been described as an example, the same damage evaluation method can be used for the case of a cement concrete pavement, polymer concrete, and plastics, for example.

In a cement concrete mixture, however, neutralization occurs, and decalcification occurs in a neutralized portion, and a vermiculate state is induced, increasing the number of voids. Generally, in cement concrete of a structure, cracks occur inside, and the width, length, and direction of cracks are unknown, and thus, under present circumstances, it is not known from the outside whether the cement concrete is sound. In terms of this point, according to the present method, it is possible to determine whether a crack is present on a surface of aggregate or in the aggregate, and, as a result of the determination, when a crack is present on a surface of the aggregate, it can be judged that the crack is formed due to thermal destruction (crack due to a change in temperature), and, when a crack is present in the aggregate, it can be judged that the crack is formed due to a mechanical load. Therefore, in a cement concrete mixture, what force causes a crack in cement concrete can be clarified by the location or shape of the crack.

On the other hand, in an asphalt mixture, with the passage of vehicles, voids gradually become smaller by consolidation action, and at the same time, a crack is gradually formed inside and becomes thicker. For example, in ten years after construction of an existing base course which is shown in FIG. 24(B), numerous thick cracks run inside in a diagonal direction. On the other hand, in a new base course, such cracks are not present at all (see FIG. 28(B), for example). By visual observation, samples of the two cannot be distinguished from each other at all.

Specific determination criteria will be described below using actual measurement examples. In addition, the term “specific determination criteria” as used herein refers to evaluation criteria (threshold values) for determining an internal damage state (the presence or absence and degree of damage), which are used by damage determining section 128, and are those obtained by further quantifying (converting in numbers) the above-described determination criteria (1) to (3).

First, determination criteria for an asphalt mixture will be described.

Table 1 is a table showing an example of threshold values for damage determination for an asphalt mixture. Here, threshold values are set in advance for parameters A, B, C, D, a, b, c and d of eight evaluation criteria and for each type of asphalt mixture.

TABLE 1

| | DENSE GRADE/ | COARSE | MAS- | DRAIN- | TREATMENT |
|---|---|---|---|---|---|
| | BASE COURSE | GRADE | TIC | AGE | COURSE |
| A | 50 | 100 | 50 | 100 | 100 |
| B | 2000 | 3000 | 2000 | 2000 | 2000 |
| C | 30 | 80 | 30 | 100 | 100 |
| D | 4 | 4 | 4 | 5 | 4 |
| a | 6 × 10⁶ | 6 × 10⁶ | 6 × 10⁶ | 1 × 10⁷ | 6 × 10⁶ |
| b | 1000 | 2000 | 1500 | 2000 | 1000 |
| c | 1000 | 2000 | 1000 | 2000 | 1000 |
| d | 0.4 | 0.6 | 0.5 | 0.6 | 0.5 |

Here, parameters A, B, C, D, a, b, c and d of the evaluation criteria are defined as follows. In addition, each term in the definitions are as already described.

A: Maximum value (or average value) of a pore volume (the unit is mm³)

B: Maximum value (or average value) of an effective pore radius (the unit is μm)

C: Difference between the minimum value and maximum value of an average adjacent pore volume (the unit is mm³)

D: Maximum value of adjacent pore coordination number

a: Maximum value (or average value) of a throat surface area (the unit is μm²)

b: Maximum value (or average value) of an effective throat radius (the unit is μm)

c: Difference between the maximum value and minimum value of an average effective adjacent pore radius (the unit is μm)

d: Maximum value of effective throat radius/average effective adjacent pore radius

In addition, in table 1, as parameters A, B, a and b, maximum values are shown.

Further, the meanings of abbreviations in the table regarding the types of asphalt mixture are as follows.

“Dense grade”: means a continuous grading type (dense-graded type) asphalt mixture. This mixture is normally used for a surface course of the first layer (surface course mixture). Because of aggregate being densely packed, such a name is provided. In this mixture, the maximum aggregate particle size is as small as substantially 13 to 20 mm, and thus, the mixture has characteristics that the texture of a surface is fine.

“Base course”: means an asphalt mixture used for the second layer of an asphalt pavement. For this mixture, normally, one with a somewhat rough surface texture such as a maximum aggregate particle size of 20 mm is used. The amount of asphalt in the mixture also decreases for the lower layers. In addition, the following mastic asphalt may be used for a base course (second layer).

“Coarse grade”: means a coarse-graded type asphalt mixture. This mixture is a surface course mixture, as with the dense-graded type, but is a mixture having surface texture rougher than that of a dense-graded type mixture. The maximum aggregate particle size is 13 to 20 mm which is substantially the same as that of the dense-graded type. However, this mixture contains a somewhat smaller amount of asphalt than the dense-graded type, and is a mixture having surface made resistant to slipping.

“Mastic”: means mastic asphalt. Mastic asphalt is a mixture that does not require roller compaction, and is completed just by pouring. Mastic asphalt is used for a base course in a bridge made of a steel plate deck, but is used for a surface course in a general roadway.

“Drainage”: means a drainage asphalt mixture. This mixture has the same maximum particle size as a coarse-graded type mixture, but is a mixture having surface roughness and water penetration improved by removing aggregates with a particle size of 2 to 5 mm to obtain discontinuous grading. This mixture has no water splash and is resistant to slipping, and thus, all of the surface courses of Japanese expressways are of this type.

“Treatment course”: means an asphalt treated base course, that is, an asphalt mixture for use in the third layer of an asphalt pavement. This mixture has a maximum aggregate particle size of 40 mm.

In addition, the values of parameters A, B, C, D, a, b, c and d of the evaluation criteria are obtained as analysis results of void analyzing section 126.

The numbers in table 1 are threshold values. When the value of a measured parameter is less than a threshold value, it is determined that there is no damage to the mixture, that is, the mixture is sound. On the other hand, when the value of a measured parameter is greater than or equal to a threshold value, it is determined that there is damage to the mixture. When describing, as an example, the case of a dense-graded type or base course mixture, according to table 1, when the value of parameter A is less than 50, the value of parameter B is less than 2000, the value of parameter C is less than 30, the value of parameter D is less than 4, the value of parameter a is less than 6×10⁶, the value of parameter b is less than 1000, the value of parameter c is less than 1000, and the value of parameter d is less than 0.4, in each case, it is determined that there is no damage to the mixture. On the other hand, when the value of parameter A is greater than or equal to 50, the value of parameter B is greater than or equal to 2000, the value of parameter C is greater than or equal to 30, the value of parameter D is greater than or equal to 4, the value of parameter a is greater than or equal to 6×10⁶, the value of parameter b is greater than or equal to 1000, the value of parameter c is greater than or equal to 1000, and the value of parameter d is greater than or equal to 0.4, in each case, it is determined that there is damage to the mixture.

However, as shown in the following actual measurement examples, the presence, or absence of damage mainly depends on the value of parameter D or d. Therefore, by comparing the value of parameter D or d with a threshold value in table 1, the presence or absence of damage can be substantially determined. In addition, other determination criteria than parameters D and d are effective for determining not only damage but also variations in the construction, mix, and the like of materials.

Further, the threshold values (determination criteria) can be arbitrarily set by a user. Here, each threshold value is decided, for example, by assessing the conditions of each of new and existing mixtures and determining whether there is damage.

Tables 2 to 18 each show an actual measurement example for an asphalt mixture. In each table, for parameters A, B, a and b, a number in the top row indicates a maximum value, and a number in parentheses in the bottom row indicates an average value. For parameter c, numbers in the top row indicate a maximum value and a minimum value (here, described as “minimum value−maximum value”), and a number in the bottom row indicates a difference between the maximum value and the minimum value. In each table, a mixture surrounded by a square indicates a mixture that is recognized to have damage by determination using threshold values in table 1, and a number surrounded by a square indicates a measurement value at which it is determined that there is damage, by comparison with a threshold value in table 1.

For parameters A, B, a and b, variations in the quality of a mixture are preferably seen with a maximum value rather than an average value. This is because, taking look at the actual measurement examples, although variations in average value are small, variations in maximum value are large, and the maximum value of a void or crack is a great decisive factor in the case of damage (damage develops from a large void or crack). However, it is possible to use an average value as a threshold value for damage determination.

TABLE 2

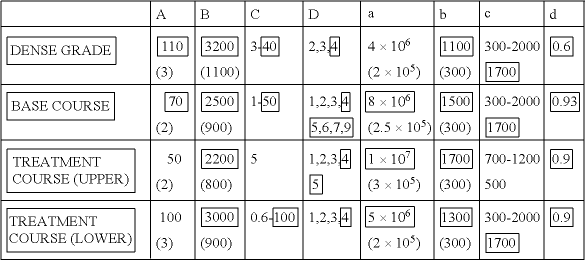

Table 2 shows a measurement example for an Iwamizawa pavement section of the Hokkaido Expressway. This measurement example shows results of performing a three-dimensional CT analysis by the present method on a sample (having a three-layer structure of a surface course, a base course and a treatment course) which is cut out in a vertical direction from an asphalt layer. The sample is taken from a location of the surface course (dense-graded type mixture) where five years have elapsed since construction and a location of layers including the base course and layers below the base course, where ten years have elapsed since construction.

Here, “treatment course (upper)” and “treatment course (lower)” in table 2 respectively indicate an upper portion and a lower portion of the same asphalt treated base course. An asphalt treated base course is generally thick in thickness, and therefore, here, to standardize a measurement target to a thickness of 2 to 3 cm, the asphalt treated base course is divided into two portions, the upper and lower portions, and then measurement is performed.

In this sample, as shown in table 2, in all of the courses, the measurement values of parameters D and d are greater than or equal to threshold values shown in table 1, and thus, it is determined that there is damage.

TABLE 3

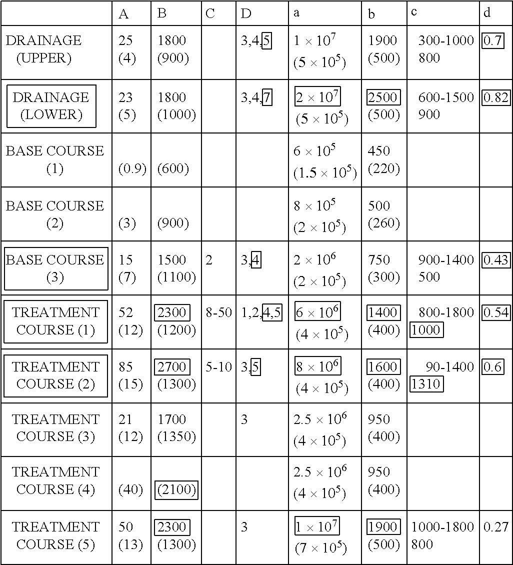

Table 3 shows a measurement example for a new Kembuchi pavement section not in service of the Hokkaido Expressway. This measurement example shows results of performing a three-dimensional CT analysis by the present method on a sample (having a three-layer structure of a surface course, a base course and a treatment course) which is cut out in a vertical direction from an asphalt layer. The sample is taken from a new location of all of the courses.

Here, “drainage (upper)” and “drainage (lower)” in table 3 respectively indicate an upper portion and a lower portion of the same surface course of a drainage mixture. “Base course (1)”, “base course (2)” and “base course (3)” respectively indicate, in order from the top, three portions into which the same base course is divided. “Treatment course (1), “treatment course (2)”, “treatment course (3)”, “treatment course (4)” and “treatment course (5)” respectively indicate, in order from the top, five portions into which the same treatment course is divided.

In this sample, as shown in table 3, for the courses of “drainage (upper)”, “drainage (lower)”, “base course (3)”, “treatment course (1)” and “treatment course (2)”, the measurement values of parameters D and d are greater than or equal to the threshold values shown in table 1, and thus, it is determined that there is damage.

Tables 4 to 8 show the case of a sample taken from the Kyoto-Jukan Expressway which is extremely strictly constructed and quality controlled compared to normal expressways. Here, a sample is taken from each of four sections (section A-1, section A-2, section B and section X) of the Kyoto-Jukan Expressway. In each section, all of the surface courses are a drainage pavement. The characteristics of each section are as follows.

Section A-1: a section that uses aggregate produced by Sakoda (the aggregate is broken up in a normal way, and flat stone is also mixed. Therefore, when included in a mixture, both fine voids and large voids are present. Accordingly, stone that is difficult for water to penetrate and easily chokes is used. Produced in Kyoto) and uses, as drainage pavement asphalt, Ecophalt TA (trade name) manufactured by Nippon Oil Corporation.

Section A-2: a section that uses aggregate produced in Hiramoto, Kyushu (aggregate broken up twice and completed in a cubic shape is used. Even with the same grading, there are many large voids, the quality is good, and there are extremely few small voids, and thus, it is difficult to choke) and uses, as drainage pavement asphalt, the above-described Ecophalt TA (trade name).

Section B: a section that uses aggregate produced in Hiramoto and the above-described Ecophalt TA (trade name). It is a pavement on a bridge, and, in a steel plate deck bridge, the movement of the bridge is larger than that of general roadways, and therefore it is known that damage to the pavement occurs earlier.

Section X: a section that uses aggregate produced in Hiramoto and uses, as asphalt, Sealoflex (trade name) manufactured by Obayashi Road Corporation.

TABLE 4

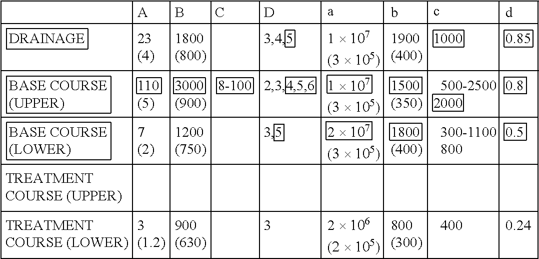

Table 4 shows a measurement example for a sample taken from the section A-1 of the Kyoto-Jukan Expressway. The sample is taken from a location of all of the sections where eight years have elapsed since construction.

Here, “base course (upper)” and “base course (lower)” in table 4 respectively indicate an upper portion and a lower portion of the same base course. “Treatment course (upper)” and “treatment course (lower)” respectively indicate an upper portion and a lower portion of the same asphalt treated base course.

In this sample, as shown in table 4, for the courses of “drainage”, “base course (upper)” and “base course (lower)”, the measurement values of parameters D and d are greater than or equal to the threshold values shown in table 1, and thus, it is determined that there is damage.

TABLE 5

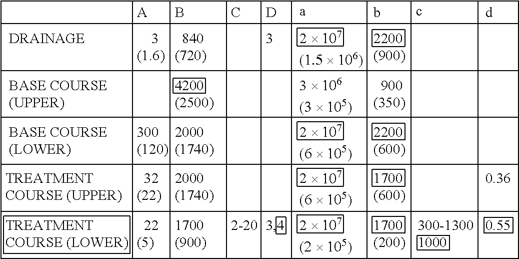

Table 5 shows a measurement example for a sample taken from the section A-2 of the Kyoto-Jukan Expressway. The sample is taken from a location of all of the sections where eight years have elapsed since construction.

Here, “base course (upper)” and “base course (lower)” in table 5 respectively indicate an upper portion and a lower portion of the same base course. “Treatment course (upper)” and “treatment course (lower)” respectively indicate an upper portion and a lower portion of the same asphalt treated base course.

In this sample, as shown in table 5, only for the course of “treatment course (lower)”, the measurement values of parameters D and d are greater than or equal to the threshold values shown in table 1, and thus, it is determined that there is damage.

TABLE 6

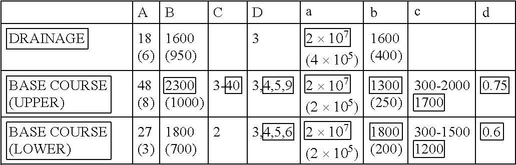

Table 6 shows a measurement example for a sample taken from the section B of the Kyoto-Jukan Expressway. The sample is taken from a location of all of the sections where eight years have elapsed since construction.

Here, “base course (upper)” and “base course (lower)” in table 6 respectively indicate an upper portion and a lower portion of the same base course.

In this sample, as shown in table 6, for all of the courses of “drainage”, “base course (upper)”, and “base course (lower)”, the measurement values of parameters D and d are greater than or equal to the threshold values shown in table 1, and thus, it is determined that there is damage.

TABLE 7

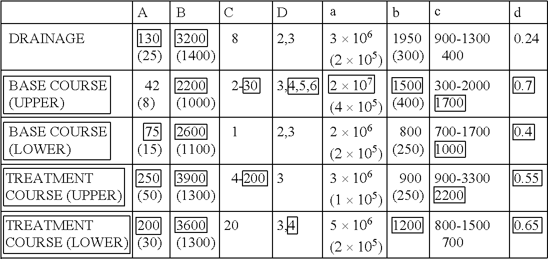

Table 7 shows a measurement example for a sample taken from the section X of the Kyoto-Jukan Expressway. The sample is taken from a location of all of the sections where eight years have elapsed since construction.

Here, “base course (upper)” and “base course (lower)” in table 7 respectively indicate an upper portion and a lower portion of the same base course. “Treatment course (upper)” and “treatment course (lower)” respectively indicate an upper portion and a lower portion of the same asphalt treated base course.

In this sample, as shown in table 7, for the courses of “base course (upper)”, “base course (lower)”, “treatment course (upper)” and “treatment course (lower)”, the measurement value of at least one of parameters D and d is greater than or equal to the threshold value shown in table 1, and thus, it is determined that there is damage.

TABLE 8

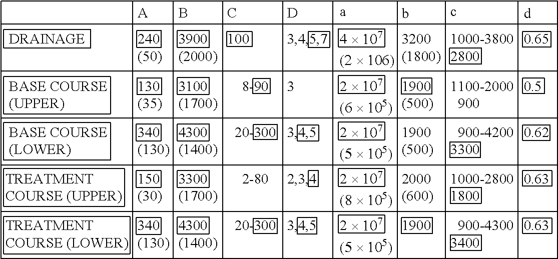

Table 8 shows a measurement example for a sample taken from section T (this section is based on standard specifications and construction) of the Kyoto-Jukan Expressway. The sample is one obtained at the time of new construction (that is, all courses are new).

Here, “base course (upper)” and “base course (lower)” in table 8 respectively indicate an upper portion and a lower portion of the same base course. “Treatment course (upper)” and “treatment course (lower)” respectively indicate an upper portion and a lower portion of the same asphalt treated base course.

In this sample, as shown in table 8, for all of the courses, the measurement value of at least one of parameters D and d is greater than or equal to the threshold value shown in table 1, and thus, it is determined that there is damage. Moreover, in all of the courses, the measurement values of parameters A, B, a and b are greater than or equal to the threshold values shown in table 1, and thus, it is determined that the degree of damage is higher than that for the cases shown in tables 4 to 7.

It can be seen from tables 4 to 8 that, in the four sections (sections A-1, A-2, B and X) having stricter specifications and construction than standard ones, the degree of damage is low even with the lapse of eight years. By comparing the degrees of damage between the four sections (sections A-1, A-2, B and X), the quality of asphalt and the quality of aggregate can be evaluated.

It can also be seen that a bridge pavement is, as expected, easy to be broken. It is extremely difficult to check such differences by conventional pavement evaluation methods.

Tables 9 and 10 show measurement examples for an Oiwake pavement section of the Doto Expressway. The measurement examples show results of performing a three-dimensional CT analysis by the present method on a sample (having a three-layer structure of a surface course, a base course and a treatment course) which is cut out in a vertical direction from an asphalt layer.

The sample is taken from a location of all of the sections where five years have elapsed since construction. In this section, the surface course is a drainage pavement and Toughphalt (trade name) manufactured by Nichireki Co., Ltd. is used.

TABLE 9

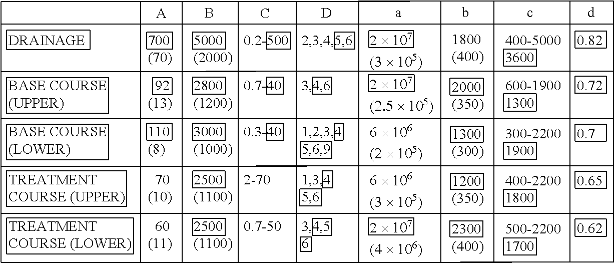

TABLE 10

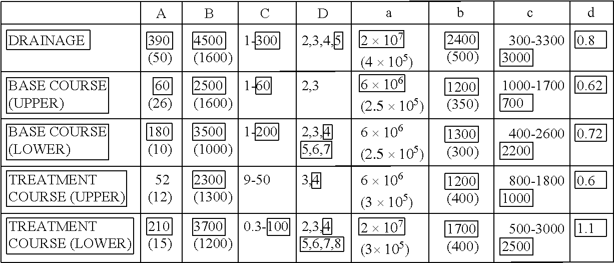

Here, table 9 shows the case where a sample is taken from the OWP (Outer Wheel Path), that is, a portion of a pavement which is the outer side of a wheel and where a tire touches, and table 10 shows the case where a sample is taken from the BWP (Between Wheel Path), that is, a portion of a pavement which is a central portion of a lane and where a wheel does not touch. In tables 9 and 10, “base course (upper)” and “base course (lower)” respectively indicate an upper portion and a lower portion of the same base course. “Treatment course (upper)” and “treatment course (lower)” respectively indicate an upper portion and a lower portion of the same asphalt treated base course.

In the case of table 9, in the sample, in all of the courses, the measurement values of parameters D and d are greater than or equal to the threshold values shown in table 1, and thus, it is determined that there is damage. In the case of table 10, in the sample, in all of the courses, the measurement value of at least one of parameters D and d is greater than or equal to the threshold value shown in table 1, and thus, it is determined that there is damage.

Tables 11 and 12 show measurement examples for a Chitose-Higashi pavement section of the Doto Expressway. The measurement examples show results of performing a three-dimensional CT analysis by the present method on a sample (having a three-layer structure of a surface course, a base course and a treatment course) which is cut out in a vertical direction from an asphalt layer. The sample is taken from a location of all of the sections where five years have elapsed since construction. In this section, the surface course is a drainage pavement, and Senaphalt (trade name) manufactured by Nisshin-Kasei Corporation is used as asphalt. In addition, this section is adjacent to the Oiwake pavement section and is different from the Oiwake pavement section in the used drainage pavement asphalt and aggregate (crushed stone), but is the same as the Oiwake pavement section in terms of the mix, and moreover, the same as the Oiwake pavement section in terms of the construction year, traffic volume and climate.

TABLE 11

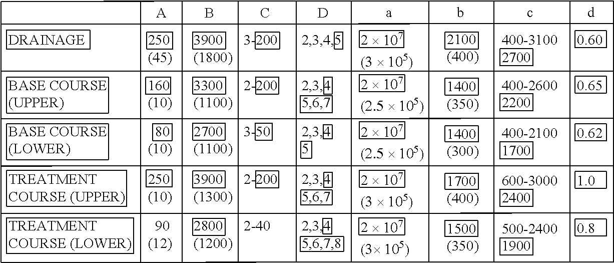

TABLE 12

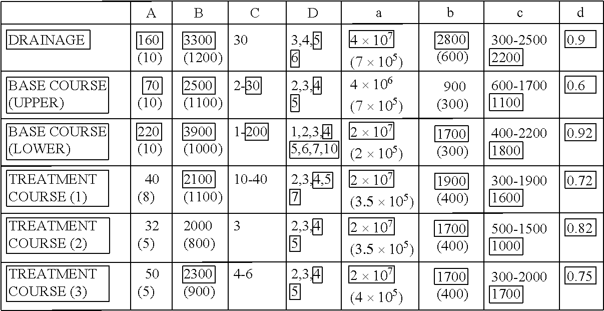

Here, table 11 shows the case where a sample is taken from the pavement in the OWP, and table 12 shows the case where a sample is taken from the pavement in the BWP. In tables 11 and 12, “base course (upper)” and “base course (lower)” respectively indicate an upper portion and a lower portion of the same base course. In table 11, “treatment course (upper)” and “treatment course (lower)” respectively indicate an upper portion and a lower portion of the same asphalt treated base course.

In table 12, “treatment course (1)”, “treatment course (2)”, and “treatment course (3)” respectively indicate, in order from the top, three portions into which the same asphalt treated base course is divided.

In the case of table 11, in the sample, in all of the courses, the measurement values of parameters D and d are greater than or equal to the threshold values shown in table 1, and thus, it is determined that there is damage. Also in the case of table 12, in the sample, in all of the courses, the measurement values of parameters D and d are greater than or equal to the threshold values shown in table 1, and thus, it is determined that there is damage.

Tables 13 and 14 show measurement examples for Yokohama Bay Bridge. The measurement examples show results of performing a three-dimensional CT analysis by the present method on a sample cut out in a vertical direction from an asphalt layer. The sample is taken from a location of a surface course (dense-graded type mixture) where seven years have elapsed since construction and a location (pavement in the OWP) of a base course (mastic asphalt) where seventeen years have elapsed since construction.

TABLE 13

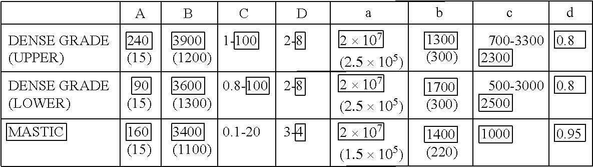

TABLE 14

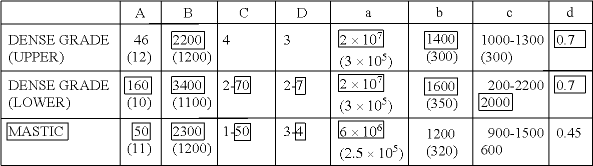

Here, table 13 shows the case where the sample is taken from a second inside lane, and table 14 shows the case where the sample is taken from a third inside lane. In tables 13 and 14, “dense grade (upper)” and “dense grade (lower)” respectively indicate an upper portion and a lower portion of the same surface course. Particularly, the surface course shown in table 13 is a pavement on steel plate deck and Shinophalt (trade name) manufactured by Nichireki Co., Ltd. is used.

In the case of table 13, in the sample, in all of the courses, the measurement values of parameters D and d are greater than or equal to the threshold values shown in table 1, and thus, it is determined that there is damage. In the case of table 14, in the sample, in all of the courses, the measurement value of at least one of parameters D and d is greater than or equal to the threshold value shown in table 1, and thus, it is determined that there is damage. In addition, from three-dimensional CT images, a sign of a vertical crack is seen only in the base course (mastic asphalt) in table 13, and thus, it is determined that there is a vertical crack.

Tables 15, 16 and 17 show measurement examples of a pavement on steel plate deck for Tsurumi-Tsubasa Bridge. The measurement examples show results of performing a three-dimensional CT analysis by the present method on a sample cut out in a vertical direction from an asphalt layer. The sample is taken from a location (pavement in the OWP) of a surface course (coarse-graded type mixture) and a base course (mastic asphalt) where thirteen years have elapsed since construction.

TABLE 15

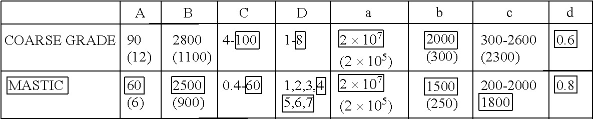

TABLE 16

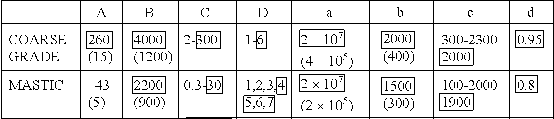

TABLE 17

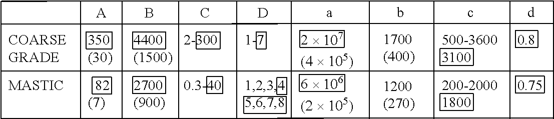

In the case of table 15, in the sample, in all of the courses, the measurement values of parameters D and d are greater than or equal to the threshold values shown in table 1, and thus, it is determined that there is damage. Also in the case of table 16, in the sample, in all of the courses, the measurement values of parameters D and dare greater than or equal to the threshold values shown in table 1, and thus, it is determined that there is damage. Also in the case of table 17, in the sample, in all of the courses, the measurement values of parameters D and d are greater than or equal to the threshold values shown in table 1, and thus, it is determined that there is damage. In addition, from three-dimensional CT images, it is determined that there is a vertical crack only in the surface course (coarse-graded type mixture) and the base course (mastic asphalt) in table 15, the base course (mastic asphalt) in table 16, and the base course (mastic asphalt) in table 17.

TABLE 18

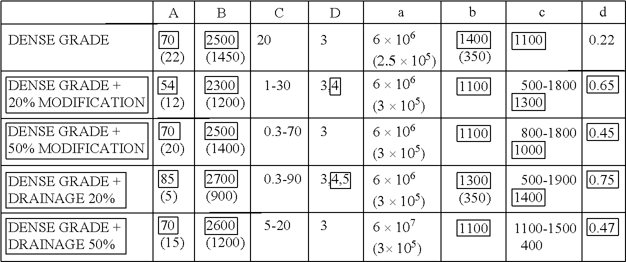

Table 18 shows a measurement example for an indoor-produced sample using a recycled material. Here, “dense grade+20% modification” means a sample produced by mixing 20% of a recycled material using a modifying material into a dense-graded type mixture. “Dense grade+50% modification” means a sample produced by mixing 50% of a recycled material using a modifying material into a dense-graded type mixture. “Dense grade+drainage 20%” means a sample produced by mixing 20% of a recycled material of a drainage mixture into a dense-graded type mixture. “Dense grade+drainage 50%” means a sample produced by mixing 50% of a recycled material of a drainage mixture into a dense-graded type mixture.

In the samples having a recycled material mixed therein, as shown in table 18, the measurement value of at least one of parameters D and d is greater than or equal to the threshold value shown in table 1, and thus, it is determined that there is damage.

As such, according to the present method, the quality of an asphalt mixture using a recycled material can be determined.

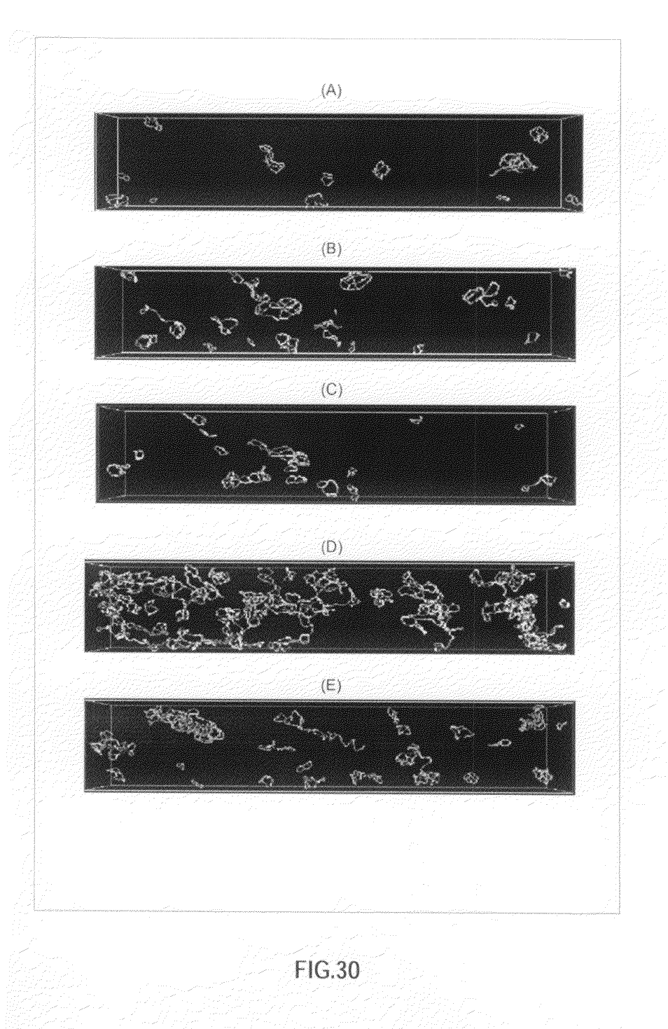

FIG. 30 shows three-dimensional computer graphics showing void analysis results for three-dimensional CT images (plane view) of the samples shown in table 18.

FIG. 30(A) shows the case of “dense grade” in table 18, that is, the case of a sample, as a standard, of only a dense-graded type mixture with no recycled material mixed therein. FIG. 30(B) shows the case of “dense grade+20% modification” in table 18, that is, the case of a sample in which 20% of a recycled material using a modifying material is mixed into a dense-graded type mixture. FIG. 30(C) shows the case of “dense grade+50% modification” in table 18, that is, the case of a sample in which 50% of a recycled material using a modifying material is mixed into a dense-graded type mixture. FIG. 30(D) shows the case of “dense grade+20% drainage” in table 18, that is, the case of a sample in which 20% of a recycled material of a drainage mixture is mixed into a dense-graded type mixture. FIG. 30(E) shows the case of “dense grade+50% drainage” in table 18, that is, the case of a sample in which 50% of a recycled material of a drainage mixture is mixed into a dense-graded type mixture.

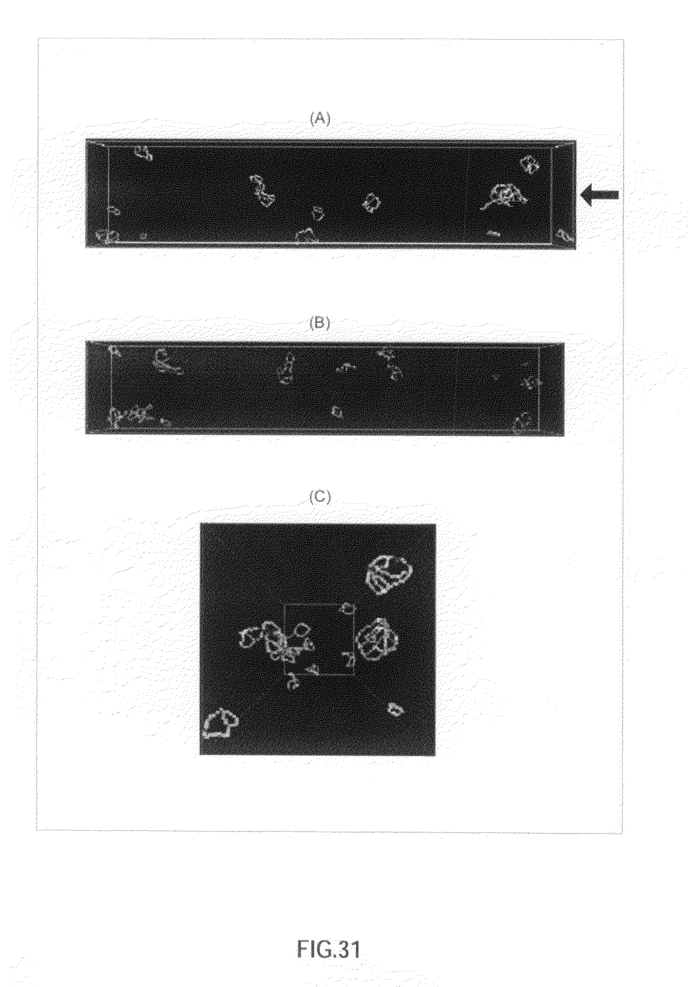

FIG. 31 shows computer graphics showing the sample in FIG. 30(A) as seen from different angles. Specifically, FIG. 31(A) is the same as FIG. 30(A) and shows three-dimensional computer graphics showing a void analysis result for a three-dimensional CT image (plane view) of the sample. FIG. 31(B) shows three-dimensional computer graphics showing a void analysis result for a three-dimensional CT image (side view) of the sample. FIG. 31(C) shows three-dimensional computer graphics showing a void analysis result for a three-dimensional CT image (side view as seen from an arrow direction in FIG. 31(A)) of the sample.

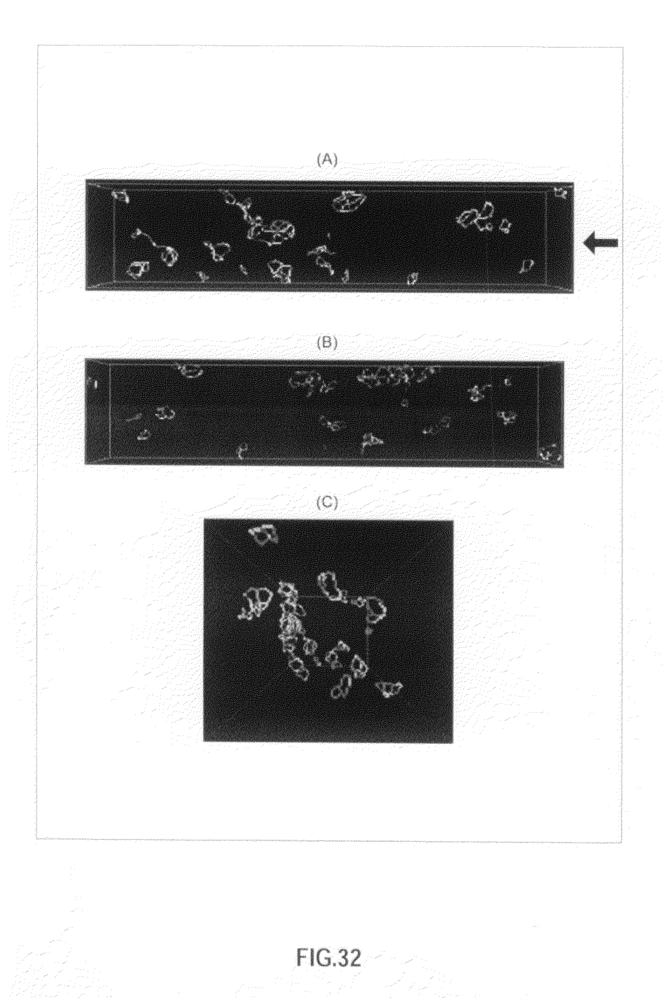

FIG. 32 shows computer graphics showing the sample in FIG. 30(B) as seen from different angles. Specifically, FIG. 32(A) is the same as FIG. 30(B) and shows three-dimensional computer graphics showing a void analysis result for a three-dimensional CT image (plane view) of the sample. FIG. 32(B) shows three-dimensional computer graphics showing a void analysis result for a three-dimensional CT image (side view) of the sample. FIG. 32(C) shows three-dimensional computer graphics showing a void analysis result for a three-dimensional CT image (side view as seen from an arrow direction in FIG. 32(A)) of the sample.

While in the dense-graded type mixture as a standard, as shown in FIG. 31, red (0.2 mm) and green (0.96 mm) cracks are observed around the aggregate, in the mixture having 20% of a recycled material (modifying material) mixed therein, as shown in FIG. 32, there are two types of cracks, red (0.24 mm) and yellow (0.48 mm), around the aggregate. This shows that when a recycled material is used, adhesion between old asphalt and new asphalt around the aggregate slightly decreases, and thus fine cracks readily occur around the aggregate. In FIG. 32, the aggregate is a portion that looks like a circle, and the circle being able to be observed in all of the three drawings indicates that asphalt around the aggregate is stripped. In this way, due to the mixing of a recycled material, fine cracks occur around the aggregate even at the time of new construction, and therefore whether a recycled material is mixed can be determined by the present method.

Next, determination criteria for a cement concrete mixture will be described.

Table 19 is a table showing an example of threshold values for damage determination for a cement concrete mixture. Here, threshold values are set for parameters A, B, C, D, a, b, c and d of eight evaluation criteria. The definitions of parameters A, B, C, D, a, b, c and d of the evaluation criteria are exactly the same as those of the above-described parameters of the evaluation criteria for an asphalt mixture.

TABLE 19

| A | B | C | D | a | b | c | d |
|---|---|---|---|---|---|---|---|
| 30 | 2000 | 30 | 4 | 1 × 10⁷ | 1000 | 1000 | 0.4 |

Also in this case, when the value of a measured parameter is less than a threshold value, it is determined that there is no damage to the mixture, that is, the mixture is sound. On the other hand, when the value of a measured parameter is greater than or equal to a threshold value, it is determined that there is damage to the mixture. For example, according to table 19, when the value of parameter A is less than 30, the value of parameter B is less than 2000, the value of parameter C is less than 30, the value of parameter D is less than 4, the value of parameter a is less than 1×10⁷, the value of parameter b is less than 1000, the value of parameter c is less than 1000, and the value of parameter d is less than 0.4, in each case, it is determined that there is no damage to the mixture. Inversely, when the value of parameter A is greater than or equal to 30, the value of parameter B is greater than or equal to 2000, the value of parameter C is greater than or equal to 30, the value of parameter D is greater than or equal to 4, the value of parameter a is greater than or equal to 1×10⁷, the value of parameter b is greater than or equal to 1000, the value of parameter c is greater than or equal to 1000, and the value of parameter d is greater than or equal to 0.4, in each case, it is determined that there is damage to the mixture.

However, also in this case, as shown in the following actual measurement examples, the presence or absence of damage mainly depends on the value of parameter D or d. Therefore, by comparing the value of parameter D or d with a threshold value in table 19, the presence or absence of damage can be substantially determined.

TABLE 20

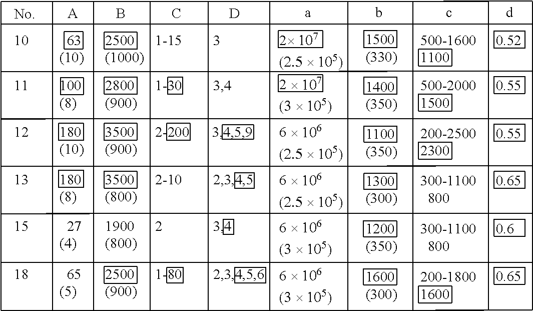

Table 20 shows a measurement example for a sample taken from one year after construct on of a cement concrete runway. The sample is taken by cutting out cement concrete with a thickness of 25 cm in a vertical direction. Sample numbers (No.) 10 to 19 indicate, in order from the top (surface side), portions of the sample divided every 2.5 cm in depth.

In all of the samples, as shown in table 20, the measurement value of at least one of parameters D and d is greater than or equal to the threshold value shown in table 19, and thus, it is determined that there is damage.

In addition, an aggregate reaction occurs in all of the samples shown in table 20. As used herein, the term “aggregate reaction” refers to a phenomenon where, when cement concrete is cured, a chemical reaction occurs between cement or an additive and aggregate on a surface of normal internal aggregate, gel is formed on the surface of the aggregate, and the gel expands, causing a crack in the cement.

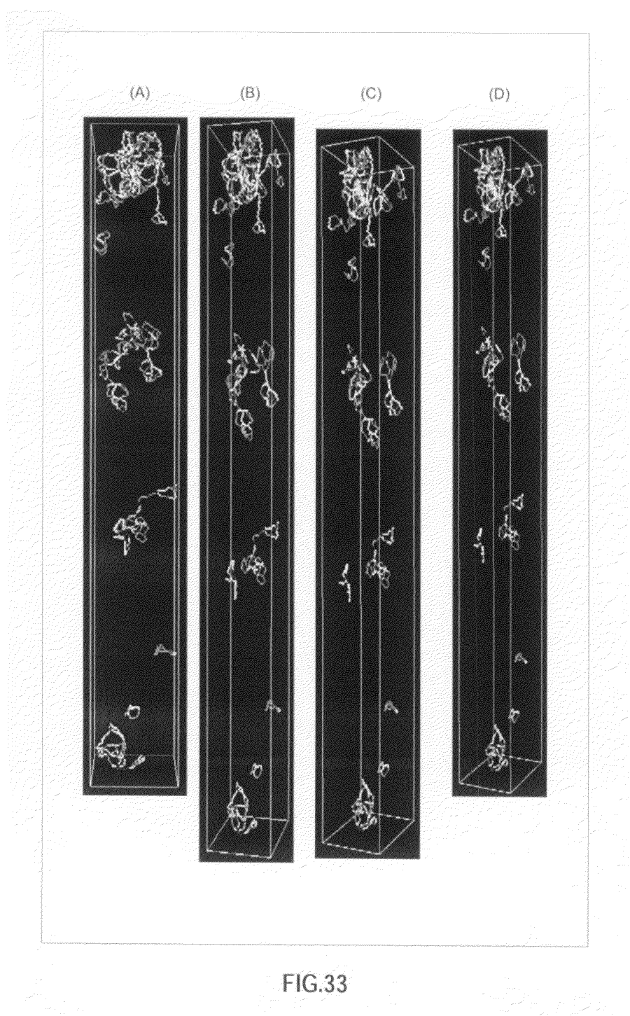

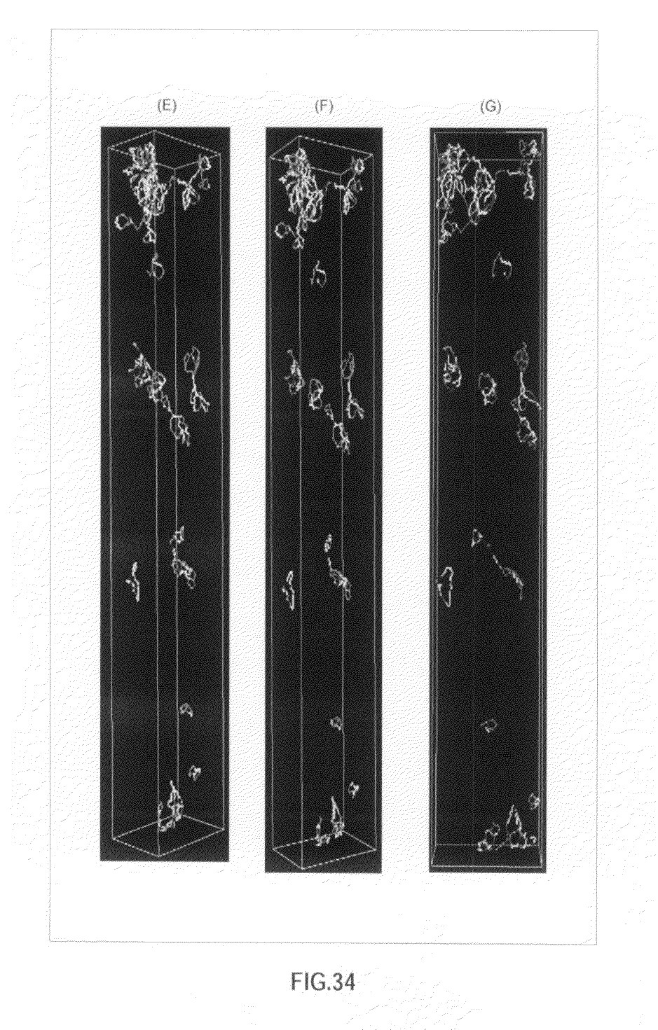

FIGS. 33 and 34 show three-dimensional computer graphics showing void analysis results for three-dimensional CT images of a sample of No. 10 (closest to the surface) shown in table 20. Here, the sample is turned by computer graphics, and void analysis results are displayed at various angles. FIG. 33(A) shows the case of a standard (plane view) (angle of 0 degree), FIG. 33(B) shows the case of a 15-degree turn (angle of 15 degrees) with the case of FIG. 33(A) being the standard, FIG. 33(C) shows the case of a 30-degree turn (angle of 30 degrees) with the case of FIG. 33(A) being the standard, FIG. 33(D) shows the case of a 45-degree turn (angle of 45 degrees) with the case of FIG. 33(A) being the standard, FIG. 34(E) shows the case of a 60-degree turn (angle of 60 degrees) with the case of FIG. 33(A) being the standard, FIG. 34(F) shows the case of a 75-degree turn (angle of 75 degrees) with the case of FIG. 33(A) being the standard, and FIG. 34(G) shows the case of a 90-degree turn (angle of 90 degrees) with the case of FIG. 33(A) being the standard.

As described above, when there are voids around an aggregate and the aggregate floats, the aggregate looks like a circle. Therefore, as shown in FIG. 33(A) to FIG. 34(G), by turning a sample, a phenomenon where an aggregate floats around the aggregate in a cement concrete mixture can be easily observed. Specifically, it can be clearly found which aggregate floats and what width of void there is, and the location, position and shape thereof can also be easily checked.

TABLE 21

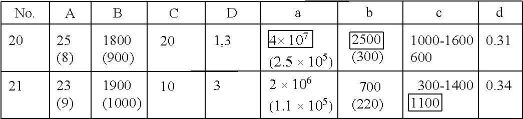

Table 21 shows a measurement example for a sample taken from concrete of Toyohira Bridge on Route 36 in Sapporo City, which is constructed thirty years ago. The sample is taken by cutting out cement concrete with a thickness of the order of 20 cm in a vertical direction. Sample numbers (No.) 20 and 21 respectively indicate an upper portion and a lower portion of the same taken sample.

In both of the samples, as shown in table 21, the measurement values of both of parameters D and d are less than the threshold values shown in table 19, and thus, it is determined that there is no damage, that is, the samples are sound. In addition, this concrete has another concrete of substantially 20 cm placed on the top thereof, internal neutralization is not developed.

TABLE 22

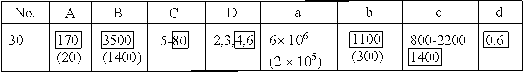

Table 22 shows a measurement example for a sample taken from neutralized concrete of a 30-year-old existing bridge in Kobe City.

In this sample (No. 30), as shown in table 22, the measurement values of parameters D and d are greater than or equal to the threshold values shown in table 19, and thus, it is determined that there is damage.

TABLE 23

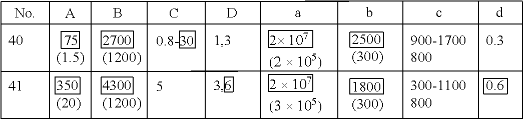

Table 23 shows a measurement example for river gravel (sample) that causes alkali-aggregate reaction (alkali-silica reaction). Sample numbers (No.) 40 and 41 respectively indicate an upper portion and a lower portion of the taken river gravel. As used herein, the term “alkali-aggregate reaction” refers to a phenomenon where alkali hydroxide contained in cement concrete reacts with an alkali reactive mineral contained in aggregate, and the reactive mineral expands, causing cracks in the shape like branches of a tree in the cement concrete.

In the sample of No. 41, as shown in table 23, the measurement values of parameters D and d are greater than or equal to the threshold values shown in table 19, and thus, it is determined that there is damage.

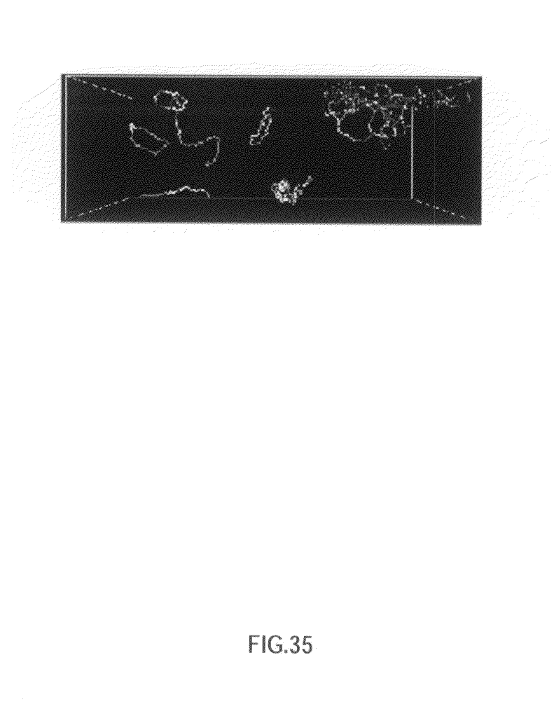

FIG. 35 shows three-dimensional computer graphics showing a void analysis result for a three-dimensional CT image of the sample (No. 41) shown in table 23, that is, the lower portion of the river gravel that causes alkali-aggregate reaction.

TABLE 24

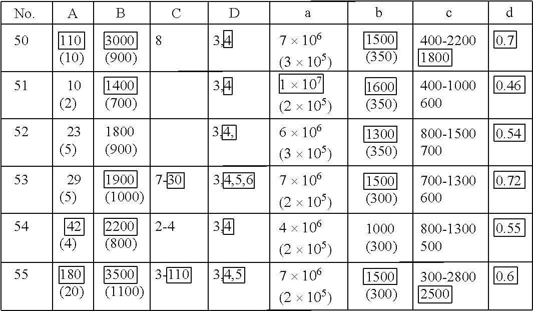

Table 24 shows a measurement example for samples taken from thirty years of ter construction of a road tunnel. The samples are taken by cutting out, in a vertical direction, concrete of two ducts (2 m×2 m) for ventilation provided at the top of the road tunnel. Sample numbers (No.) 50 to 52 respectively indicate, in order from the top, three portions into which the same sample cut out from concrete of an exhaust duct is divided. Sample numbers (No.) 53 to 55 respectively indicate, in order from the top, three portions into which the same sample cut out from concrete of an inlet duct is divided.

In all of the samples, as shown in table 24, the measurement values of parameters D and d are greater than or equal to the threshold values shown in table 19, and thus, it is determined that there is damage.

In addition, according to a neutralization test by application of phenolphthalein, in both the exhaust and inlet ducts, the upper portions are neutralized (samples of No. 50 and 53), the middle portions are sound (samples of No. 51 and 54), and the lower portions are neutralized again (samples of No. 52 and 55). This means that only by a test by application of phenolphthalein, the degree of sound of cement concrete cannot be learned.

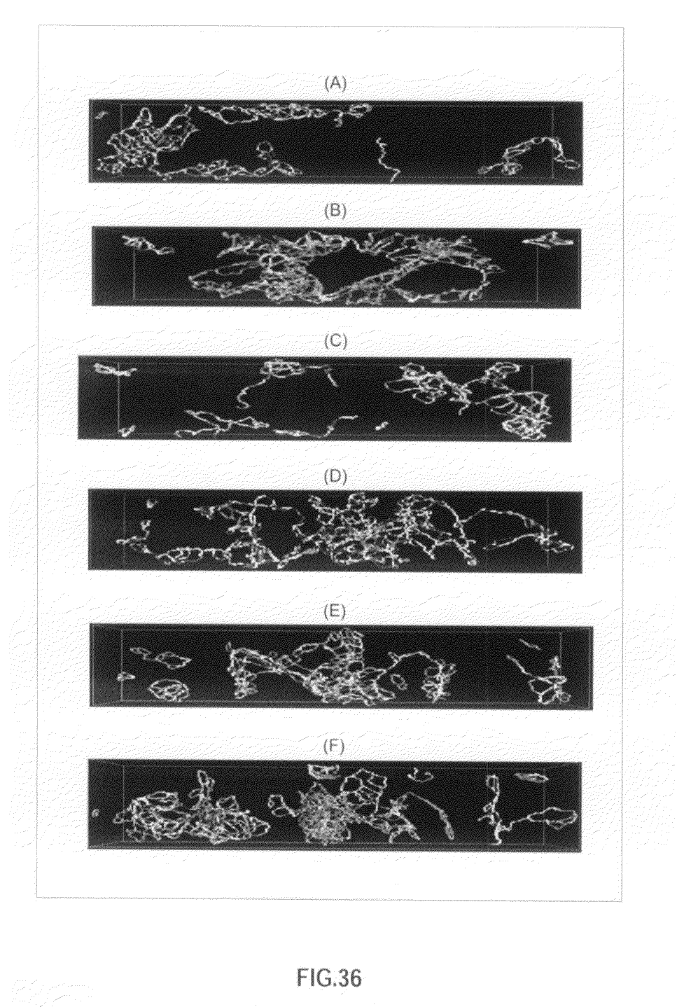

FIG. 36 shows three-dimensional computer graphics showing void analysis results for three-dimensional CT images of the samples shown in table 24. FIG. 36(A) shows the case of the sample of No. 50 (the exhaust duct, the upper portion and neutralized) in table 24. FIG. 36(B) shows the case of the sample of No. 51 (the exhaust duct, the middle portion and sound portion) in table 24. FIG. 36(C) shows the case of the sample of No. 52 (the exhaust duct, the lower portion and neutralized) in table 24. FIG. 36(D) shows the case of the sample of No. 53 (the inlet duct, the upper portion and neutralized) in table 24. FIG. 36(E) shows the case of the sample of No. 54 (the inlet duct, the middle portion and sound portion) in table 24. FIG. 36(F) shows the case of the sample of No. 55 (the inlet duct, the lower portion and neutralized) in table 24. However, as described above, the sound portion as referred to here is a result of a test by application of phenolphthalein and does not match a test result by the present method.

In this way, in the present method, a part that is determined to be sound by conventional test methods can also be accurately evaluated as having damage, and thus, it can be said that the present method is a optimal test method for quality inspection of cement concrete.

### Embodiment 2

Embodiment 2 shows the case of evaluating damage to an asphalt mixture or the like, without taking a sample from the asphalt mixture or the like which is a target of diagnosis.

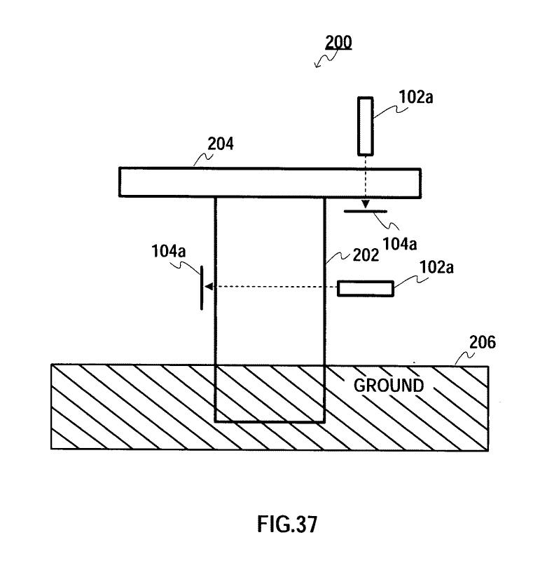

FIG. 37 is a schematic diagram showing an application example of a damage evaluation apparatus according to Embodiment 2 of the present invention. In addition, the damage evaluation apparatus shown in FIG. 37 has the same basic configuration as damage evaluation apparatus 100 shown in FIG. 1, and therefore the same components are assigned the same reference numerals without further explanations.

In the present embodiment, a sample is not taken from an asphalt mixture or the like which is a target of diagnosis, and a set of X-ray generator 102a and X-ray detector 104a is disposed so as to be rotatable in or around an asphalt mixture or the like which is a target of diagnosis. In an example of FIG. 37, an asphalt mixture or the like which is a target of diagnosis is concrete bridge 200, for example. Concrete bridge 200 includes bridge pier 202 and deck 204, and a lower portion of bridge pier 202 is buried in ground 206.

Upon diagnosis of concrete bridge 200, the set of X-ray generator 102a and X-ray detector 104a are disposed so that bridge pier 202 or deck 204 which is the target of diagnosis is put therebetween, and, after the intensity of an X-ray is decided so that the X-ray transmits through the target of diagnosis (bridge pier 202 or deck 204), irradiation of an X-ray is performed with the set of X-ray generator 102a and X-ray detector 104a being turned 360 degrees in steps of 1 degree with respect to the target of diagnosis, for example, projection data for every 1 degree is detected by X-ray detector 104a, and the data is recorded as CT scan data in computer main body 114. Subsequent processings are the same as those for the case of Embodiment 1.

In this way, according to the present embodiment, without taking a sample, damage to an asphalt mixture or the like can be nondestructively and accurately evaluated in a short period of time.

The present application is based on Japanese Patent Application No. 2005-151581, filed on May 24, the entire content of which is expressly incorporated by reference herein.

### INDUSTRIAL APPLICABILITY

A damage evaluation apparatus and a damage evaluation method according to the present invention are suitable for use as a damage evaluation apparatus and a damage evaluation method that are capable of nondestructively and accurately evaluating damage to an asphalt mixture or the like in a short period of time.

1-24. (canceled)

25. A damage evaluation apparatus comprising:
an irradiating section that irradiates a transmissive X-ray onto an evaluation object formed with a mixture, per predetermined angle;
a detecting section that is disposed opposite to the irradiating section put the evaluation object into between sections that detects the X-ray transmitted through the evaluation object;
an obtaining section that obtains, using a detection result of the detecting section, an internal state of the evaluation object in a form of three-dimensional CT image data;
a calculating section that calculates, using the three-dimensional CT image data, characteristic data of the internal state of the evaluation object; and
a determining section that determines, using the characteristic data, a damage state of an inside of the evaluation object according to a predetermined determination criterion, wherein:
the characteristic data includes information of a crack connecting voids; and
the determining section determines the damage state of the inside of the evaluation object by comparing the information of a crack with a predetermined threshold value.

26. A damage evaluation apparatus comprising:
a calculating section that calculates characteristic data of an internal state of an evaluation object using three-dimensional CT image data that is obtained by irradiating a transmissive X-ray onto the evaluation object formed with a mixture and that shows the internal state of the evaluation object; and
a determining section that determines, using the characteristic data, a damage state of an inside of the evaluation object according to a predetermined determination criterion, wherein:
the characteristic data includes information of a crack connecting voids; and
the determining section determines the damage state of the inside of the evaluation object by comparing the information of a crack with a predetermined threshold value.

27. A damage evaluation apparatus comprising:
a calculating section that calculates characteristic data of an internal state of an evaluation object using three-dimensional CT image data that is obtained by irradiating a transmissive X-ray onto the evaluation object formed with a mixture and that shows the internal state of the evaluation object, wherein:
the characteristic data includes information of a crack connecting voids; and
the information of a crack is used to determine a damage state of an inside of the evaluation object by comparing the information of a crack with a predetermined threshold value.

28-38. (canceled)

39. A CT image creating apparatus for damage evaluation comprising:
an irradiating section that irradiates a transmissive X-ray onto an evaluation object formed with a mixture, per predetermined angle;
a detecting section that is disposed opposite to the irradiating section put the evaluation object into between sections that detects the X-ray transmitted through the evaluation object; and
an obtaining section that obtains, using a detection result of the detecting section, an internal state of the evaluation object in a form of three-dimensional CT image data, the three-dimensional CT image data being used to calculate characteristic data of the internal state of the evaluation object, the characteristic data being information of a crack connecting voids, the information of a crack being used to determine a damage state of an inside of the evaluation object by comparing the information of a crack with a predetermined threshold value.

40-42. (canceled)

43. A damage evaluation method comprising:
an irradiation step of irradiating a transmissive X-ray onto an evaluation object formed with a mixture, per predetermined angle;
a detection step of detecting the X-ray transmitted through the evaluation object;
an obtaining step of obtaining, using a detection result in the detection step, an internal state of the evaluation object in a form of three-dimensional CT image data;
a calculation step of calculating, using the three-dimensional CT image data, characteristic data of the internal state of the evaluation object; and
a determination step of determining, using the characteristic data, a damage state of an inside of the evaluation object according to a predetermined determination criterion, wherein:
the characteristic data is information of a crack connecting voids; and
in the determination step, the damage state of the inside of the evaluation object is determined by comparing the information of a crack with a predetermined threshold value.

44. A damage evaluation method comprising:
a calculation step of calculating characteristic data of an internal state of an evaluation object using three-dimensional CT image data that is obtained by irradiating a transmissive X-ray onto the evaluation object formed with a mixture and that shows the internal state of the evaluation object; and
a determination step of determining, using the characteristic data, a damage state of an inside of the evaluation object according to a predetermined determination criterion, wherein:
the characteristic data is information of a crack connecting voids; and
in the determination step, the damage state of the inside of the evaluation object is determined by comparing the information of a crack with a predetermined threshold value.

45. A damage evaluation method comprising a calculation step of calculating characteristic data of an internal state of an evaluation object using three-dimensional CT image data that is obtained by irradiating a transmissive X-ray onto the evaluation object formed with a mixture and that shows the internal state of the evaluation object, the characteristic data being information of a crack connecting voids, the information of a crack being used to determine a damage state of an inside of the evaluation object by comparing the information of a crack with a predetermined threshold value.

46. A CT image creating method for damage evaluation comprising:
an irradiation step of irradiating a transmissive X-ray onto an evaluation object formed with a mixture, per predetermined angle;
a detection step of being disposed opposite to the irradiating section put the evaluation object into between sections detecting the X-ray transmitted through the evaluation object; and
an obtaining step of obtaining, using a detection result of the detecting section, an internal state of the evaluation object in a form of three-dimensional CT image data, the three-dimensional CT image data being used to calculate characteristic data of the internal state of the evaluation object, the characteristic data being information of a crack connecting voids, the information of a crack being used to determine a damage state of an inside of the evaluation object by comparing the information of a crack with a predetermined threshold value.

47-48. (canceled)
